(19) United States
(12) Patent Application Publication
(10) Pub. No.: US 2015/0310466 A1
(43) Pub. Date: Oct. 29, 2015

(54) SALES ANALYZER SYSTEMS AND METHODS

(71) Applicant: TrueCar, Inc., Santa Monica, CA (US)

(72) Inventors: Jacob Michael LaCivita, Los Angeles, CA (US); Scott Stephany, Los Angeles, CA (US); Michael D. Swinson, Santa Monica, CA (US); Thomas Taira, Berkeley, CA (US)

(21) Appl. No.: 14/696,241

(22) Filed: Apr. 24, 2015

Related U.S. Application Data
(60) Provisional application No. 61/984,479, filed on Apr. 25, 2014.

(51) Int. Cl. G06Q 30/02; G06Q 10/08

(52) U.S. Cl. CPC G06Q 30/0205; G06Q 10/087

(57) ABSTRACT

Sales data and vehicle data may be collected by a vehicle data system embodying a special sales analyzer application. For each dealer affiliated or registered with the system and each vehicle transaction record received from the dealer, the system may run analytics to determine, compute, and/or impute supplemental data and internal vehicle pricing data such as trim-level vehicle configuration data, price ranges, exclusion reasons, dealer-specific recommendations, etc. that can later be used to generate a dealer-facing custom user interface. The results are collated into a comprehensive database and persisted in a data store. When requested by a dealer, the system may retrieve dealer-specific information, including sales prices, salespeople, average dealer margins, sales volumes, etc., and anonymized sales data from others in the same geographic region as the dealer and display a visual presentation of all transactions and also individual transactions for that dealer.

### CROSS-REFERENCE TO RELATED APPLICATION(S)

This application is a conversion of, and claims a benefit of priority under 35 U.S.C. §119 from U.S. Provisional Application No. 61/984,479, filed Apr. 25, 2014, entitled “SALES ANALYZER SYSTEMS AND METHODS,” which is hereby fully incorporated by reference herein, including its appendices.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This disclosure relates generally to automotive transactions. More particularly, embodiments disclosed herein relate to systems, methods, and tools for analyses and evaluations of automotive transactions.

### BACKGROUND OF THE RELATED ART

Traditionally, dealerships do not share sales data with other dealerships, particularly those that might be local competitors. Lacking such data usually means that dealerships are unable to accurately analyze and objectively evaluate their own sales data and determine how they perform relative to others. Furthermore, dealerships, particularly new car dealerships, lack the ability to visualize the prices for which they have sold vehicles. Thus, historically, for a dealership to analyze their sales, they must put in a lot of time, resources, and efforts to cross reference data between multiple systems, providers, and sources, often costing more than a typical automotive dealership can afford or is willing to invest. Even assuming they have access to a reliable source of historical market data and the means to interpret the data, the resulting analysis may not provide an accurate and/or complete picture of how well they are doing, particularly in the context of their local market. Consequently, there is room for innovations and improvements.

### SUMMARY OF THE DISCLOSURE

Understanding price competitiveness and profitability in relation to timing and geographic considerations can lead to more educated pricing decisions and sustainable profitability. Accordingly, it is an object of the invention to provide context in how an automotive dealer's pricing compares relative to other dealers in a geographic area. This geographic area may be predetermined or dynamically defined. It is another object of the invention to provide an automotive dealer with a comprehensive view of their sales performance, geographically and/or demographically, as well as per sales personnel. Additionally, it is an object of the invention to provide tools and/or recommendations useful for an automotive dealer to improve their sales. For example, a dealer-facing interface may be presented on a client device communicatively connected to an embodiment of a sales analyzer system, the dealer-facing interface showing an inventory of an automotive dealer, the current demand as determined based on proprietary market data, and an inventory or inventories of one or more competitors within a geographic area where the automotive dealer is located.

The level of details shown in a dealer-facing interface may vary. For example, through a dealer-facing interface, a sales analyzer system may show a dealer in Shiner, Tex. that the demand for trucks is high and that the dealer has a low inventory of trucks relative to their competitor(s) in the area, and may recommend increasing their inventory level of trucks. As another example, the sales analyzer system may show the same dealer that the demand for green passenger cars is low and that the dealer has high inventory of green passenger cars relative to their competitor(s) in the area, and may recommend decreasing their inventory level of green passenger cars by, for instance, lowering the prices of their green passenger cars. Additionally, the sales analyzer system may suggest new target prices, where to advertise and/or through what advertising channel(s), etc. to facilitate the dealer in increasing their sales performance.

These and other objects and features of the invention may be realized in a method comprising receiving automotive transaction data associated with a particular dealer in a geographic area; running analytics including analyzing the received automotive transaction data associated with the dealer in the geographic area relative to anonymized information on vehicle sales aggregated across multiple dealers in the geographic area; and storing results from the analytics in a data store. The method may further comprise receiving a request from the dealer to analyze their sales occurred in a particular time period, querying the data store with one or more parameters from the request, and generating a custom user interface for the dealer based at least in part on the analyzed sales data retrieved from the data store. The one or more parameters may represent corresponding filter(s) that the dealer has selected via a web site. The custom user interface may include one or more visual representations of the selectively filtered and analyzed sales data for the dealer, proving various possible ways for the dealer to improve sales/performance. The method may further comprise determining one or more recommendations for the dealer based at least in part on the analyzed sales data for the dealer.

One embodiment comprises a system comprising a processor and a non-transitory computer-readable storage medium that stores computer instructions translatable by the processor to perform a method substantially as described herein. Another embodiment comprises a computer program product having a non-transitory computer-readable storage medium that stores computer instructions translatable by a processor to perform a method substantially as described herein.

Numerous other embodiments are also possible.

Embodiments disclosed herein can provide many advantages. For example, with a vehicle sales analysis tailored to a dealer relative to their geographic area, the dealer can better target their customers and price new vehicles in order to increase sales and improve margins. Further, using sophisticated pricing algorithms and comprehensive automotive related data, the custom vehicle sales analysis can provide useful insights previously unavailable the dealer, including how well they perform as compared to other dealers in their geographic area.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 depicts one embodiment of a topology including a vehicle data system;

FIG. 2 depicts a diagrammatic representation of a sales analyzer system according to some embodiments;

FIG. 3 depicts a flow diagram illustrating an example embodiment of a sales analyzer method;

FIG. 4 depicts a flow diagram illustrating another example embodiment of a sales analyzer method;

FIGS. 5A-5B depict a flow diagram illustrating another example embodiment of a sales analyzer method;

FIGS. 6-15 provide numerical examples implementing an embodiment of a sales analyzer method;

FIGS. 16A-16D depict diagrammatic representations of various views of an example embodiment of a custom user interface, showing a first visualization type; and

FIGS. 17A-17B depict diagrammatic representations of various views of another example embodiment of a custom user interface, showing a second visualization type.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Before discussing specific embodiments, a brief overview of the context of the disclosure may be helpful.

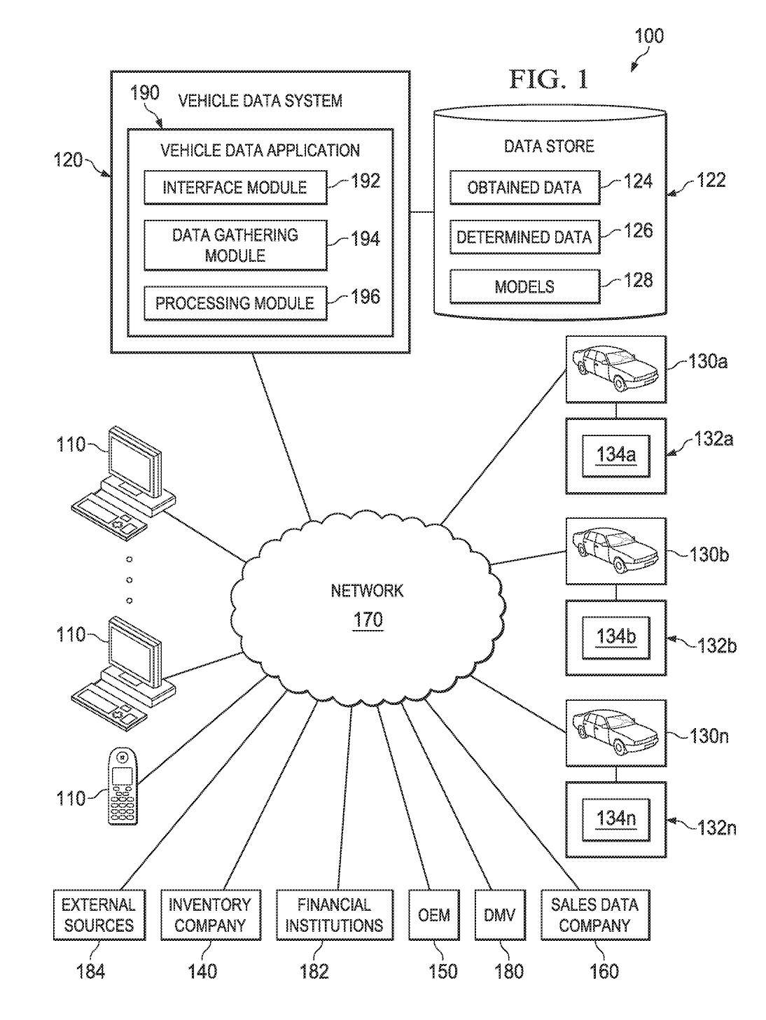

FIG. 1 depicts one embodiment of a topology which may be used to implement embodiments of the systems and methods disclosed herein. Topology 100 comprises a set of entities including vehicle data system 120 which is coupled through network 170 to computing devices 110 (e.g., computer systems, personal data assistants, kiosks, dedicated terminals, mobile telephones, smart phones, etc.), and one or more computing devices at inventory companies 140, original equipment manufacturers (OEM) 150, sales data companies 160, financial institutions 182, external information sources 184, departments of motor vehicles (DMV) 180 and one or more associated point of sale locations, in this embodiment, car dealers 130a . . . n. Computing devices 110 may be used by consumers while conducting a search for consumer goods and/or services, such as automobiles. Network 170 may be for example, a wireless or wired communication network such as the Internet or wide area network (WAN), publicly switched telephone network (PTSN) or any other type of electronic or non-electronic communication link such as mail, courier services or the like.

Vehicle data system 120 may comprise one or more computer systems with central processing units executing instructions embodied on one or more computer readable media where the instructions are configured for vehicle data system 120 to perform at least some of the functionality associated with embodiments disclosed herein. These applications may include a vehicle data application 190 comprising one or more applications (instructions embodied on one or more non-transitory computer readable media) configured to implement an interface module 192, data gathering module 194 and processing module 196 utilized by the vehicle data system 120. Furthermore, vehicle data system 120 may include data store 122 operable to store obtained data 124, data 126 determined during operation, models 128 which may comprise a set of dealer cost model or price ratio models, or any other type of data associated with embodiments disclosed herein or determined during the implementation of those embodiments.

As an example, a dealer cost model may be generated for each of a set of manufacturers by analyzing invoice data corresponding to that manufacturer (which may be received from dealers). In particular, the invoice data may be analyzed to determine the equation for deriving holdback in the dealer cost relationship (for example, where dealer cost=invoice −holdback). The invoice data usually provided with each vehicle invoice may contain the following: the holdback price, the invoice price, the freight charges and MSRP, among other data. Thus, taking each vehicle invoice as a separate observation and assuming that each equation for the dealer cost always takes a similar form, the various forms of the equation can be plotted to see which equation holds most consistently across observations. The equation which holds most consistently can be deemed to be the holdback equation (referred to as a dealer cost model) for that manufacturer. Accordingly, each make of vehicle (manufacturer) has an associated dealer cost model stored in models 128.

In addition to dealer cost models, a price ratio regression equation (referred to as a price ratio model) may be determined using historical transaction data. For example, utilizing global multivariable regression, a price ratio model may be of the form f(x)=Σᵢ₌₀ⁿΣₖ₌₀^{m}(βᵢXᵢX_{bk}) where Xᵢ signifies global variables, X_{bk} signifies bin-level variables for specific bins b, and βᵢ's are coefficients. Expressed another way, PriceRatio=a0+a1*PRbin+a2*PRbin*dealercost+a3*PRbin*cylinders+a4*PRbin*drive+a5*PRbin*daysinmarket+Σ(aₖ*PRbin*stateₖ) where aᵢ=coefficients, PRbin is the 4-week average price ratios for all transactions in a bin associated with a given vehicle, dealercost is a steady-state (incentives adjusted) dealer cost for the given vehicle, cylinders are the number of cylinders the given has, drive is the number of drive wheel in the drivetrain (e.g. 2 or 4 wheel drive), daysinmarket is the number of days the model of the given vehicle has been on the marketplace and state is an array of indicator variables specifying the geographic state of purchase. With this price ratio model, it is possible to compute average price paid for the given vehicle where average price paid (Avg Price Paid) equals PriceRatio (as determined from the price ratio regression equation) multiplied by DealerCost (as determined from the dealer cost model for the manufacturer of the given vehicle) or Avg Price Paid=PriceRatio(DealerCost).

Additional details and examples of dealer cost models and price ratio models can be found in U.S. Patent Application Publication No. US 2010/0070343 A1, which is fully incorporated herein by reference. Other pricing models may also be possible and may be stored in models 128. For example, U.S. Patent Application Publication No. US 2013/0006876 A1, which is also fully incorporated herein by reference, provides a geo-specific price estimation model that is both geographic and data driven, leveraging a spatial hierarchy with increasingly coarse levels of resolution such that an estimation of pricing at the highest level of resolution may be possible provided that a data quality standard is met. Once the level of geographic resolution is determined (one that meets the data quality standard), a geo-specific vehicle price margin ratio can be estimated using the geo-specific price estimation model.

Vehicle data system 120 may provide a wide degree of functionality, including utilizing one or more interfaces 192 configured to, for example, receive and respond to queries from users at computing devices 110; interface with inventory companies 140, manufacturers 150, sales data companies 160, financial institutions 182, DMVs 180 or dealers 130 (130a, 130b, . . . , 130n) to obtain data; or provide data obtained, or determined, by vehicle data system 120 to any of inventory companies 140, manufacturers 150, sales data companies 160, financial institutions 182, DMVs 180, external data sources 184 or dealers 130. It will be understood that the particular interface 192 utilized in a given context may depend on the functionality being implemented by vehicle data system 120, the type of network 170 utilized to communicate with any particular entity, the type of data to be obtained or presented, the time interval at which data is obtained from the entities, the types of systems utilized at the various entities, etc. Thus, these interfaces may include, for example, web pages, web services, a data entry or database application to which data can be entered or otherwise accessed by an operator, or almost any other type of interface which it is desired to utilize in a particular context.

Using these interfaces 192, vehicle data system 120 may obtain data 124 from a variety of sources, including one or more of inventory companies 140, manufacturers 150, sales data companies 160, financial institutions 182, DMVs 180, external data sources 184 or dealers 130a . . . n and store such data in data store 122. This data may be then grouped, analyzed or otherwise processed by vehicle data system 120 to determine desired data 126 or models 128 which are also stored in data store 122.

A user at computing device 110 may access vehicle data system 120 through the provided interfaces 192 and specify certain parameters, such as a desired vehicle configuration or incentive data the user wishes to apply, if any. The vehicle data system 120 can select a particular set of data in the data store 122 based on the user specified parameters, process the set of data using processing module 196 and models 128, generate interfaces using interface module 192 using the selected data set on the computing devices 110 and data determined from the processing, and present these interfaces to the user at the user's computing device 110. Interfaces 192 may visually present the selected data set to the user in a highly intuitive and useful manner.

A visual interface may present at least a portion of the selected data set as a price curve, bar chart, histogram, etc. that reflects quantifiable prices or price ranges (e.g., “average,” “good,” “great,” “overpriced,” etc.) relative to reference pricing data points (e.g., invoice price, Manufacturer's Suggested Retail Price (MSRP), dealer cost, market average, internet average, etc.). Using these types of visual presentations may enable a user to better understand the pricing data related to a specific vehicle configuration. Additionally, by presenting data corresponding to different vehicle configurations in a substantially identical manner, a user can easily make comparisons between pricing data associated with different vehicle configurations. To further aid the understanding for a user of the presented data, the interface may also present data related to incentives which were utilized to determine the presented data or how such incentives were applied to determine presented data.

Turning to the various other entities in topology 100, dealer 130 (130a, 130b, . . . , or 130n) may be a retail outlet for consumer goods and/or services, such as vehicles manufactured by one or more of OEMs 150. To track or otherwise manage sales, finance, parts, service, inventory and back office administration needs, dealer 130 (130a, 130b, . . . , or 130n) may employ a dealer management system (DMS) 132 (132a, 132b, . . . , or 132n, respectively). Since many DMSs 132a . . . n are Active Server Pages (ASP) based, transaction data 134 (134a, 134b, . . . , or 134n, respectively) may be obtained directly from the DMS 132 with a “key” (for example, an ID and Password with set permissions within the DMS system 132) that enables data to be retrieved from the DMS system 132. Many dealers 130 may also have one or more web sites which may be accessed over network 170, where pricing data pertinent to the dealer 130 may be presented on those web sites, including any predetermined, or upfront, pricing. When dealers 130a . . . n present prices online through inventory management providers, these online prices may be referred to as “internet prices”. Such internet prices are generally not “no-haggle” prices. However, when dealers 130a . . . n present pricing information through vehicle data system 120, the prices are guaranteed “no-haggle” prices (i.e., prices with no negotiation). Thus, an “internet price” for a dealer's 2014 Honda Accord on Cars.com is likely to be the same price that appears on AutoTrader, MSN Autos, etc., but the no-haggle price for the same vehicle through vehicle data system 120 is likely to be unique to vehicle data system 120.

Inventory companies 140 may be one or more inventory polling companies, inventory management companies or listing aggregators which may obtain and store inventory data from one or more of dealers 130a . . . n (for example, obtaining such data from DMS 132a . . . n). Inventory polling companies are typically commissioned by the dealer to pull data from a DMS 132 and format the data for use on web sites and/or by other systems. Inventory management companies provide tools and interfaces to allow dealers to manage their own inventories. Some inventory management companies may further upload or present inventory information (photos, description, specifications) on behalf of the dealer. Listing aggregators may get dealer inventory directly from inventory feeds. For example, a dealer may sign up with a dealership inventory management company such as HomeNet. HomeNet pulls the dealer's vehicle inventory out of the DMS and then publishes it to sites like AutoTrader on behalf of the dealer. There are also “scraping” sites such as AutoTempest that do not necessarily have access to inventory feeds.

DMVs 180 may collectively include any type of government entity to which a user provides data related to a vehicle. For example, when a user purchases a vehicle it must be registered with the state (for example, DMV, Secretary of State, etc.) for tax and titling purposes. This data typically includes vehicle attributes (for example, model year, make, model, mileage, etc.) and sales transaction prices for tax purposes.

Financial institution 182 may be any entity such as a bank, savings and loan, credit union, etc. that provides any type of financial services to a participant involved in the purchase of a vehicle. For example, when a buyer purchases a vehicle they may utilize a loan from a financial institution, where the loan process usually requires two steps: applying for the loan and contracting the loan. These two steps may utilize vehicle and consumer information in order for the financial institution to properly assess and understand the risk profile of the loan. Typically, both the loan application and loan agreement include proposed and actual sales prices of the vehicle.

Sales data companies 160 may include any entities that collect any type of vehicle sales data. For example, syndicated sales data companies aggregate new and used sales transaction data from DMS 132a . . . n of particular dealers 130a . . . n. These companies may have formal agreements with dealers 130a . . . n that enable them to retrieve data from dealer 130 in order to syndicate the collected data for the purposes of internal analysis or external purchase of the data by other data companies, dealers, and OEMs.

Manufacturers 150 can be those entities which actually build the vehicles sold by dealers 130a . . . n. To guide the pricing of their vehicles, manufacturers 150 may provide an Invoice price and a Manufacturer's Suggested Retail Price (MSRP) for both vehicles and options for those vehicles—to be used as general guidelines for the dealer's cost and price. These fixed prices are set by the manufacturer and may vary slightly by geographic region.

External information sources 184 may comprise any number of other various source, online or otherwise, which may provide other types of desired data, for example data regarding vehicles, pricing, demographics, economic conditions, markets, locale(s), consumers, etc.

It should be noted here that not all of the various entities depicted in topology 100 are necessary, or even desired, in embodiments disclosed herein, and that certain of the functionality described with respect to the entities depicted in topology 100 may be combined into a single entity or eliminated altogether. Additionally, in some embodiments other data sources not shown in topology 100 may be utilized. Topology 100 is therefore exemplary only and should in no way be taken as imposing any limitations on embodiments disclosed herein.

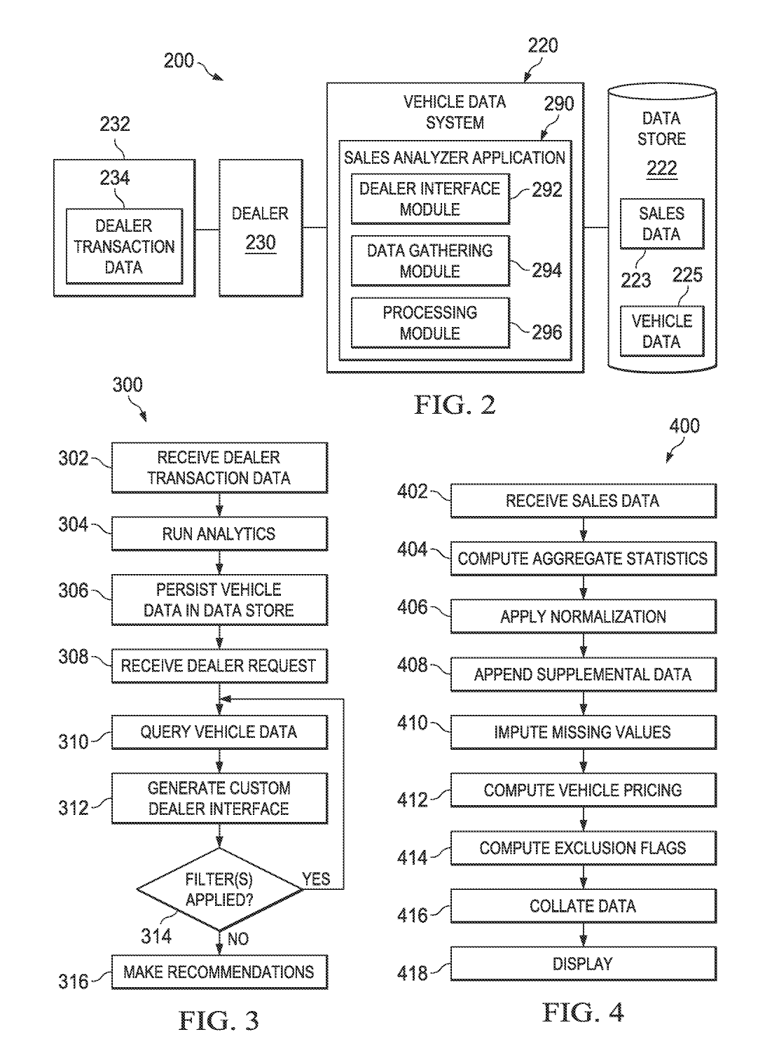

Some embodiments of topology 100 may be adapted to implement a sales analyzer system, a diagrammatic representation of which is shown in FIG. 2. For example, sales analyzer system 200 may comprise vehicle data system 220 implementing an embodiment of vehicle data system 120 described above with respect to topology 100. Vehicle data system 220 may include sales analyzer application 290 running on one or more server machines. In some embodiments, sales analyzer application 290 may comprise dealer interface module 292, data gathering module 294, and processing module 296. In some embodiments, dealer interface module 292 may be configured for generating a dealer-facing custom user interface with various user-configurable filters. As will be explained in greater detail below, the dealer-facing custom user interface can provide a dealer with various ways to compare and visualize how the dealer is performing in vehicle sales relative to other dealers in a particular geographic area.

As shown in FIG. 2, sales analyzer application 290 may be communicatively connected or otherwise have access to data store 222. In some embodiments, data store 222 may implement an embodiment of data store 122 described above and may store sales data 223 and vehicle data 225.

In some embodiments, sales data 223 may include anonymized information on sales aggregated across multiple dealers. In the context of this disclosure, data anonymization refers to an information sanitization process by which identifying particulars such as specific dealerships, customer names, and/or sales people's names are removed from data received or otherwise obtained from various data sources.

In some embodiments, data gathering module 294 may implement an embodiment of data gathering module 194 described above and may receive or otherwise obtain sales information from various data sources. For example, in some embodiments, data gathering module 294 may obtain or receive sales data sets from sales data company 160 and/or DMS 132a . . . n (e.g., via DMS feeds) described above with reference to FIG. 1. The received or obtained sales data sets are processed (e.g., by processing module 296 of sales analyzer application 290) to remove identifying particulars and stored in data store 222 as part of sales data 223. Note that the anonymized data sets are still stored at the individual transaction record level. However, identifiable information such as customer names, sales people, and so on is removed.

In some embodiments, vehicle data 225 may include build data obtained or received from manufacturers (e.g., OEMs 150). In some embodiments, vehicle data 225 may also include dealer transaction records and inventory data obtained or received from inventory companies and/or dealers (e.g., inventory companies 140 and/or dealers 130a . . . n described above with reference to FIG. 1).

For example, data gathering module 294 may receive or otherwise obtain dealer transaction data 234 associated with dealer 230 via DMS 232. Dealer transaction data 234 may include transaction records detailing pricing information particular to dealer 230, the specific salesperson or persons involved in a vehicle purchase, the transaction date for the vehicle purchase, the specific vehicle transacted, inventory data, etc. Dealer 230 may be representative of dealers 130a . . . n. Accordingly, dealer transaction data 234 for each dealer 230 may be obtained and persisted in data store 222 as part of vehicle data 225.

In some embodiments, processing module 296 may implement an embodiment of processing module 196 described above and may be utilized by sales analyzer application 290 to process data from data gathering module 294 and provide results to dealer interface module 292.

As explained in greater detail below, dealer interface module 292 is configured for generating dealer-facing customer user interfaces for dealers affiliated and/or registered with vehicle data system 220. For a specific dealer, vehicle data system 220 can aggregate to their particular local range and can present, not only a sales analysis curve (or histogram), but also individual transactions. As described above, sales data 223 contains anonymized data sets aggregated across multiple dealerships and stored at the individual transaction record level without identifying particulars that would tie to any individual dealerships.

Even so, general location information is retained. Accordingly, vehicle data system 220 can determine, for each specific dealer, what other dealerships, if any, can be considered in the same region (or a geographical boundary such as a zip code, city, county, state, designated market area, etc.) and can analyze the dealer's transactions relative to all the transactions aggregated from such other dealership(s) without needing to identify them.

For example, suppose a particular region has three dealerships A, B, and C. Sales data 223 may include anonymized transaction records aggregated across multiple dealerships including dealerships A, B, and C. Vehicle data 225 may include granular, dealer-specific data such as transaction records, sales people, inventory data, etc. for each of dealerships A, B, and C. In some embodiments, vehicle data system 220 may, on its own initiative, analyze each dealer's transactions relative to all the transactions aggregated from other dealerships in the same region and store the results in association with the individual dealer. Running the analytics and preparing corresponding presentation information independent of user requests can greatly reduce the response time needed to service a request in real time. Alternatively, in some embodiments, vehicle data system 220 may run the analytics and prepare corresponding presentation information in response to a request from a particular dealer.

An example embodiment of a sales analyzer method will now be described with reference to FIG. 3. In some embodiments, vehicle data system 220 may be particular configured for implementing method 300.

In this example, method 300 may comprise vehicle data system 220 obtaining or receiving vehicle transaction data associated with a particular dealer in a geographic area (step 302). Vehicle data system 220 may run a plurality of logical analyses (referred to herein as analytics) including analyzing the obtained/received vehicle transaction data associated with the dealer in the geographic area relative to anonymized sales data aggregated from other dealer(s) in the same geographic area (step 304). Vehicle data system 220 may store in data store 222 results from the analyses as part of vehicle data associated with the particular dealer (step 306).

In some embodiments, steps 302, 304, and 306 may be performed at a predetermined time interval. In some embodiments, steps 302, 304, and 306 may be performed daily, independent of any user requests received via a web site supported by vehicle data system 220. As described above, steps 302, 304, and 306 may be performed for each dealer affiliated or registered with vehicle data system 220 such that vehicle data 225 has dealer-specific information including results from the analytics.

In some embodiments, the analytics may include computation of vehicle prices relative to a market. In some embodiments, the vehicle prices are for new vehicles. In some embodiments, the vehicle prices are associated with one or more vehicle models. In some embodiments, the vehicle prices are associated with one or more vehicle manufacturers. In some embodiments, computing prices relative to the market may include the following steps:
Standardize prices: adjust price field to be prior to any trade-in, fee, or incentive adjustment.
Append incremental data: merge with incentives data feeds to get standard, default customer rebates.
Pass these prices through an application programming interface (API) to a pricing application (e.g., vehicle data application 190) that will return Good, Great, Below and Above Market ranges: Adjust the price by the total of the customer rebates and feed into a vehicle pricing algorithm (explained below). This will assign price ranges.
Display information into these predefined ranges (e.g., counting transactions that fell into each of these ranges). As an example, bins here can be defined as fractions of standard deviations of price ratios.

In some embodiments, the analytics may further include computation of dealer margins. Computing dealer margins may include the following steps:
Assess the quality of the margin data.
Determine which methodology the dealer used to compute his margin.
Perform filtering to eliminate bad observations.
Display of the information can then be deconstructed into averages and ranges by segment, region, or sales person.

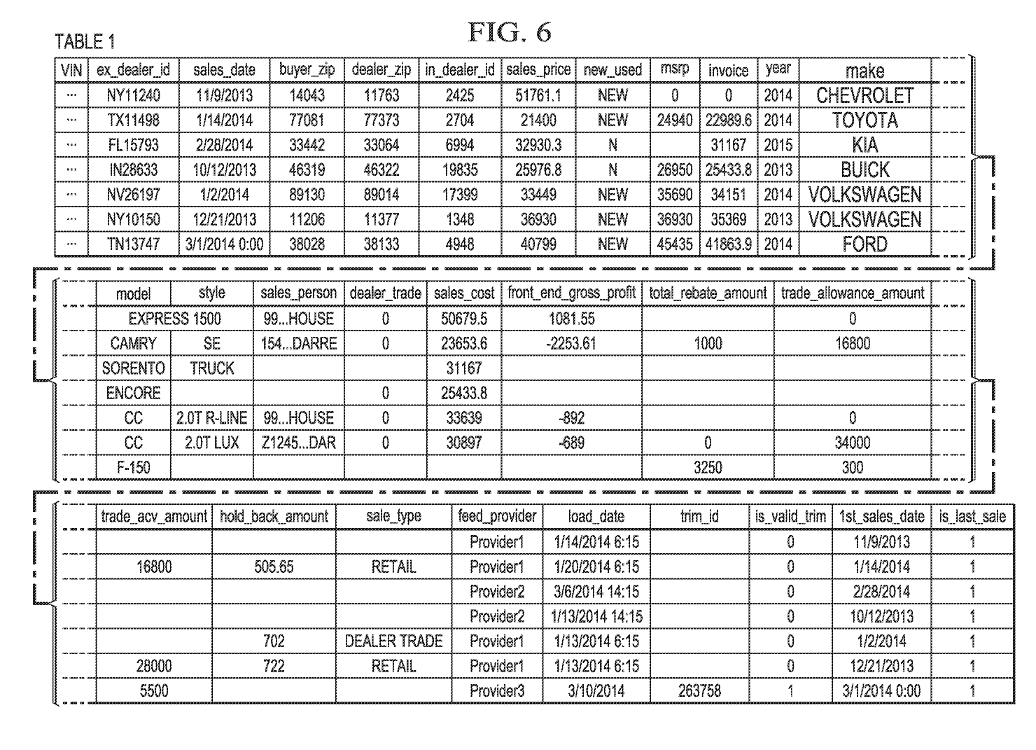

Numerical examples of the analytics are provided below with reference to FIGS. 6-15.

Referring to FIG. 3, method 300 may further comprise receiving a request from a dealer affiliated or registered with vehicle data system 220 (step 308). Vehicle data system 220 may query data store 222 and obtain vehicle data 225 specific to the requesting dealer (step 310). Based at least in part on vehicle data 225 specific to the requesting dealer, vehicle data system 220 can prepare and generate a dealer-facing custom user interface (e.g., by dealer interface module 292) for the requesting dealer such that the requesting dealer can visualize results from the analyses and possible ways to improve sales/performance (step 312).

The dealer-facing custom user interface prepared and generated by dealer interface module 292 can provide a requesting dealer with significantly more information than existing solutions. For example, a dealer-facing custom user interface for a requesting dealer may include predetermined visual presentation information such as a curve or histogram of all the transactions in a region where the requesting dealer is located and may also include individual histograms of transactions for the requesting dealer. In some embodiments, the custom user interface for the requesting dealer may also include a plurality of filters that can be configured by the requesting dealer. Each filter may be configured for selecting a different segment of information stored in vehicle data 225. For example, a salesperson filter may be configured for selecting an individual salesperson. As another example, a makes filter may be configured for selecting a particular make out of a mix of makes carried by the requesting dealer.

Responsive to a filter being selected or a change made to one of the plurality of filters (step 314), vehicle data system 220 may query data store 222 again (step 310) and generate an updated custom user interface for the requesting dealer that reflects the requested change (step 312). For example, suppose an individual salesperson is selected by the requesting dealer via the salesperson filter, the updated custom user interface may include sales data specific to the individual salesperson, including specifics on the vehicles sold by the individual salesperson such as make, model, and transaction prices for those vehicles, the market average prices for those vehicles so, the requesting dealer's margin on those vehicles, and/or other price ranges such as Below Market, Great, Good, and Above Market price ranges. The updated custom user interface in this example may thus provide the requesting dealer with an accurate overview on how the individual salesperson is performing as a sales person, including whether he is selling at prices lower than others and how that affects the requesting dealer's margin. Other features of the dealer-facing custom user interface such as various price ranges can also be selectively shown or hidden.

Method 300 may further comprise presenting one or more recommendations for the requesting dealer via the dealer-facing custom user interface (step 316). In some embodiments, the analytics may further include a recommendation analysis. In some embodiments, the recommendation analysis may be run independently of, or responsive to any dealer request. In some embodiments, the recommendation analysis may be run daily. In some embodiments, the resulting recommendation(s) may be stored in data store 222 in association with each individual dealer affiliated or registered with vehicle data system 220. In some embodiments, recommendations may be determined based at least in part on results from the analytics performed by processing module 296. For example, vehicle data system may analyze a dealer's margin in view of the dealer's inventory and make a recommendation to reduce or increase the inventory of a particular make and model.

Those skilled in the art understand that the above-described method may be implemented in various ways. FIG. 4 depicts a flow diagram illustrating another example embodiment of a sales analyzer method. In some embodiments, a vehicle data system such as vehicle data system 220 described above may be implemented to perform method 400.

More specifically, method 400 may comprise receiving or obtaining vehicle sales data (step 402) from data source(s), for instance, DMS feeds. The received data may include the most recent vehicles sales transactions associated with various vehicles carried and sold by various dealers affiliated or registered with the vehicle data system implementing method 400. The received data may be aggregated and various statistics (e.g., how many convertibles, blue cars, diesels, and so on were sold in the last 30 days, by whom, and where, etc.) may be computed (step 404). A data structure such as a table may be utilized to store rows of transaction records and columns of data fields describing various features and/or attributes about each transaction, salesperson, vehicle, etc. An example Table 1 is shown in FIG. 6. Optionally, the received data may be normalized (step 406) using a normalization technique known to those skilled in the art.

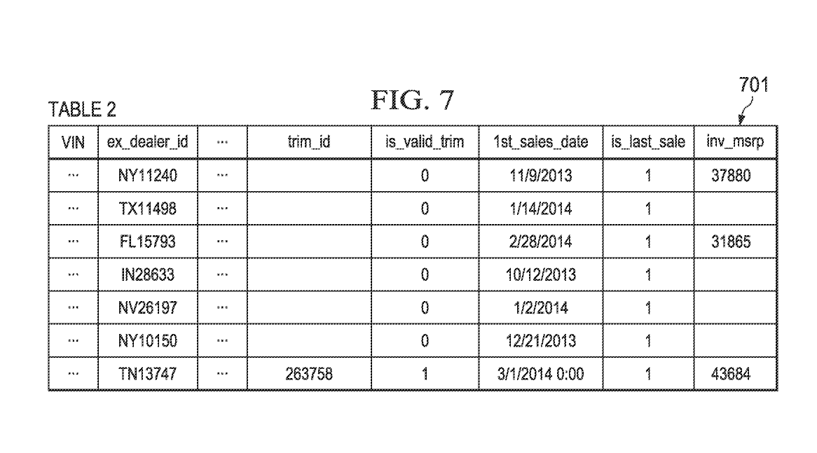

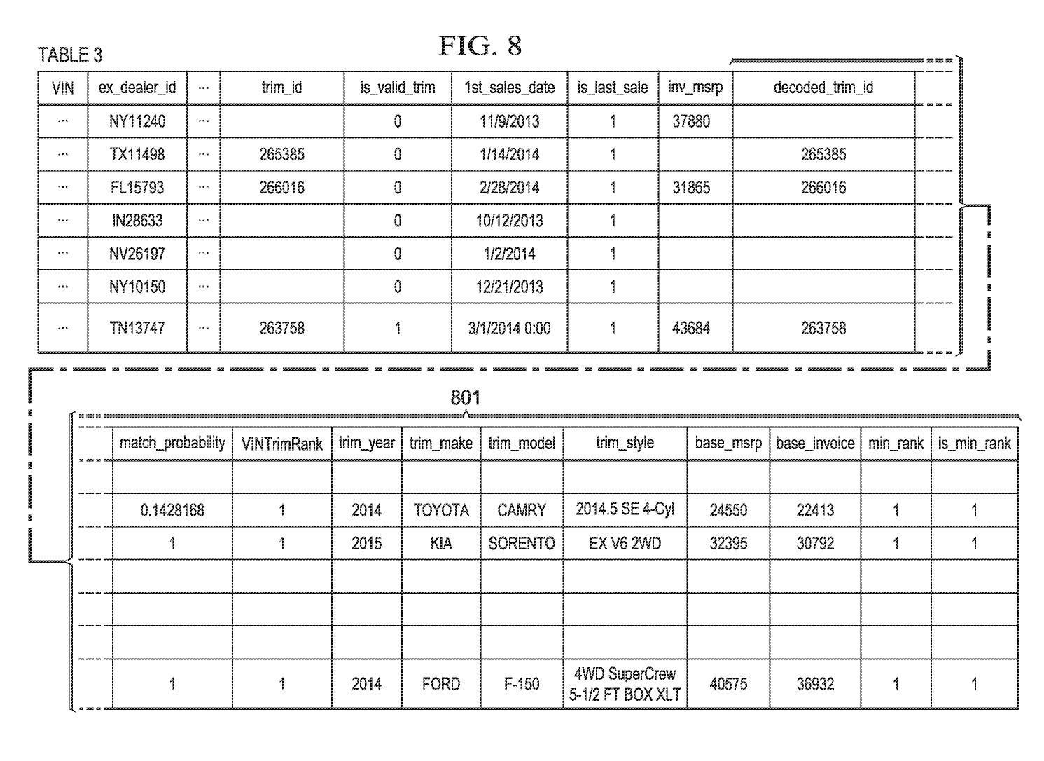

The system may determine what supplemental data can be added and, where available, append supplemental data to the table (step 408). Such supplemental data may provide more details at the trim-level for each vehicle involved in a vehicle sale. This is further explained below with reference Tables 2-3 shown in FIGS. 7-8.

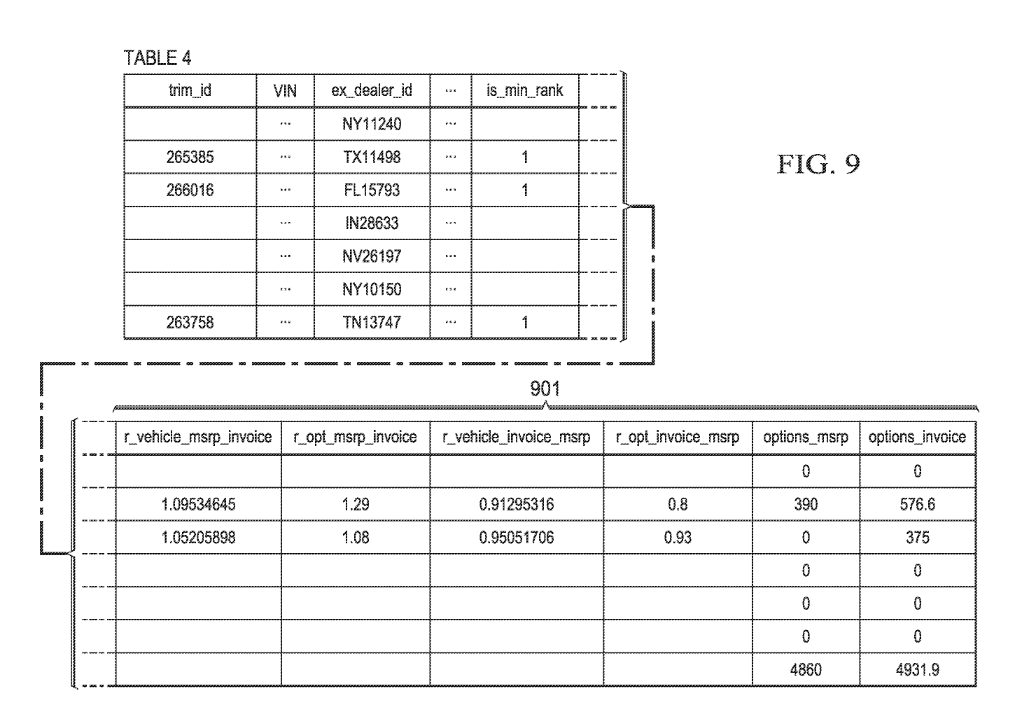

In some cases, vehicles sales transactions received via data feeds may not have MSRP and/or invoice values. Since an accurate transaction MSRP is needed to compute market pricing, the system may determine what values are missing and generate (e.g., by computation and/or imputation) (step 410) the missing values. In statistics, imputation refers to a process of replacing missing data with substitute values. For example, in the cases where a MSRP value is missing (see, e.g., Table 1), the system may look up the corresponding VIN in the inventory records and access historical new car listings data to pull the “listed price” for the VIN. Past research shows that the “listed price” in the listings data is reliably the MSRP of the vehicle. Thus, for a case where the MSRP is missing in the received data, the system can look up the VIN in the inventory records and load in the listed price as an imputed MSRP for the VIN. The system may impute a missing invoice price in a similarly manner. This is further explained below with reference to Table 4 shown in FIG. 9. The supplemental data and generated/computed/imputed values may complement the raw vehicle sales data such that the system has as many as possible reference pricing data points that describe each vehicle transaction relative to each vehicle involved and that the system can use to compute vehicle pricing data for each vehicle involved.

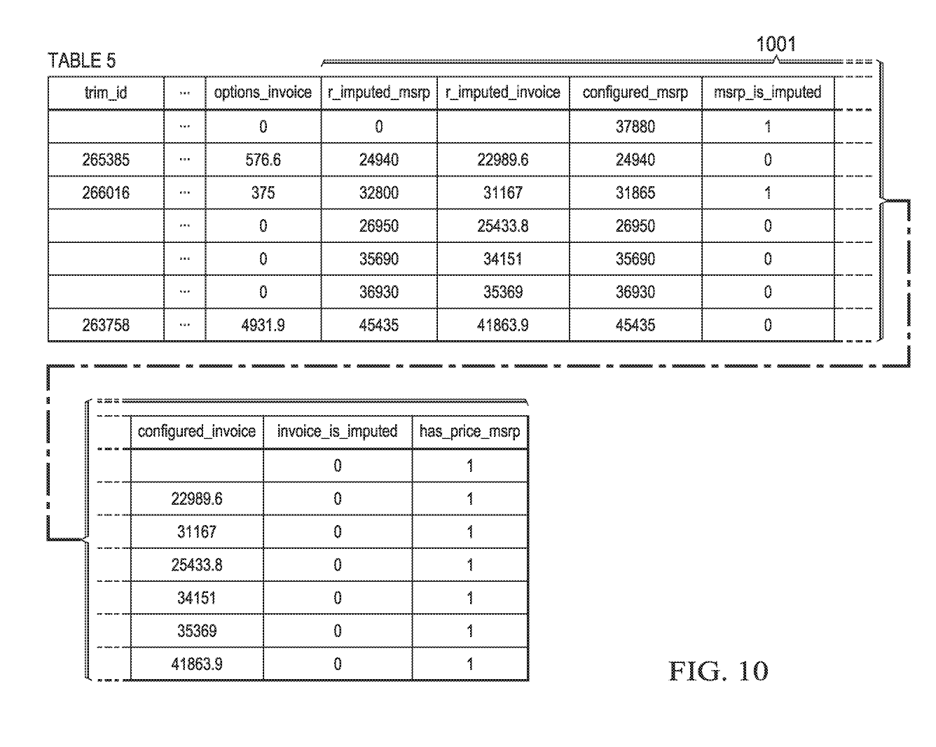

Next, internal vehicle pricing data (internal to the vehicle data system) is computed for each vehicle in a geographical area (step 412), as explained below with reference to Tables 5-9 shown in FIGS. 10-14. The geographical area may be local to a particular dealer. As described above, the geographical area may be predefined or dynamically defined. The computed vehicle pricing data may include quantifiable prices or price ranges (e.g., “average,” “good,” “great,” “overpriced,” etc.) relative to reference pricing data points (e.g., invoice price, MSRP, dealer cost, market average, internet average, etc.) in the geographical area.

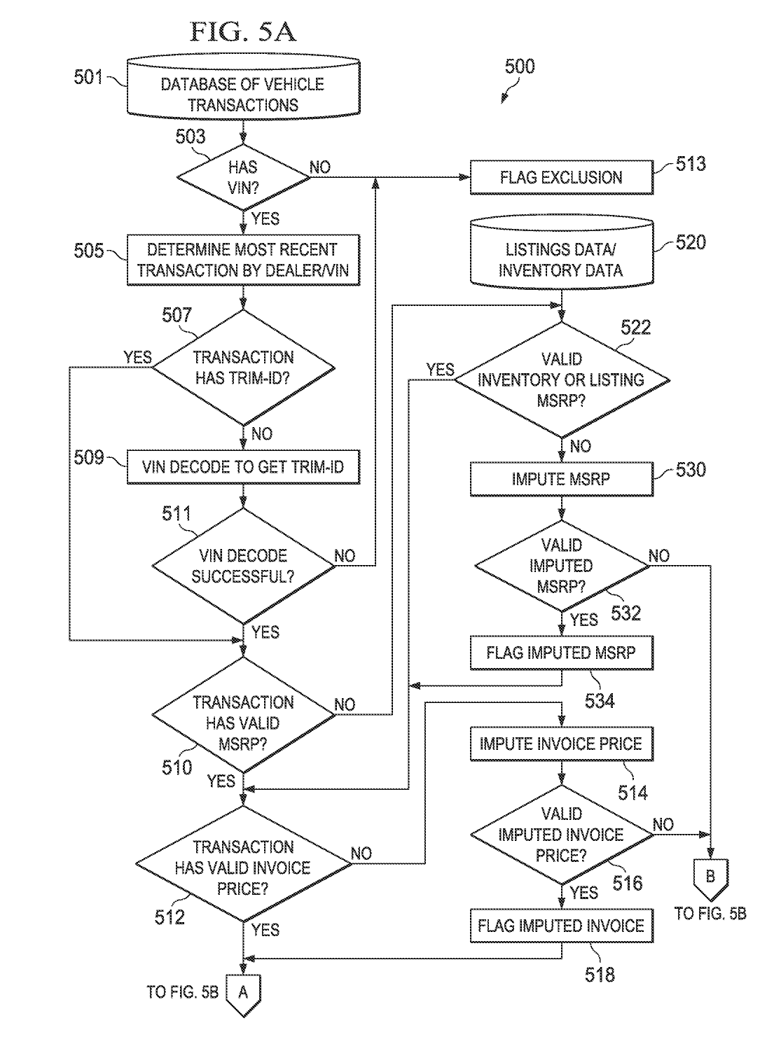

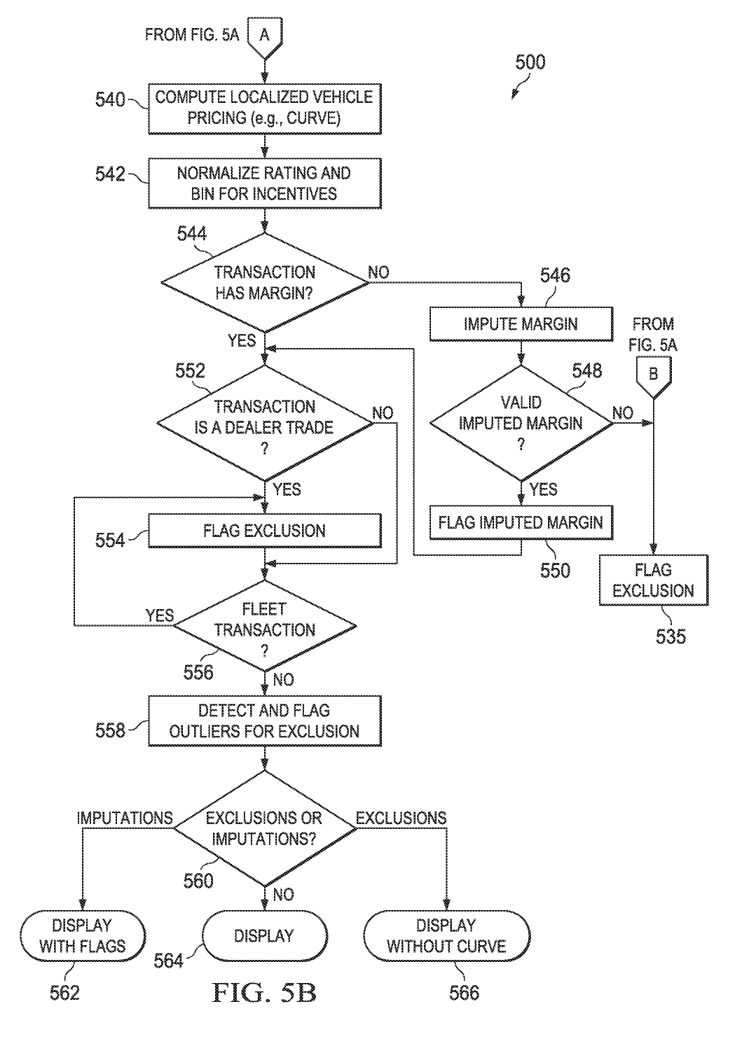

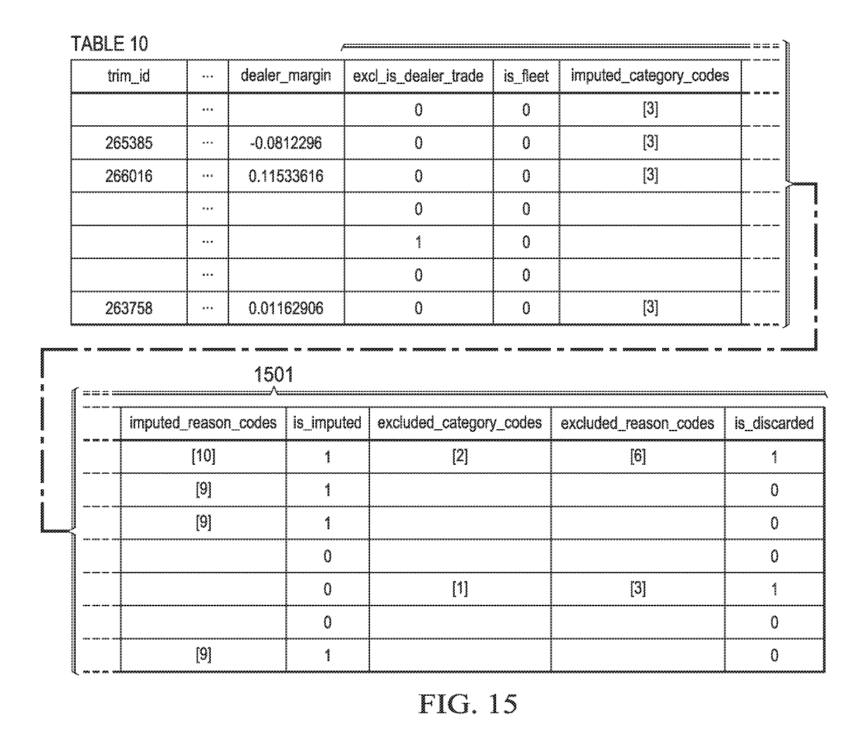

In some cases, certain data points may be excluded (step 414) so as not to skew the results of the sales analysis. For example, if a vehicle is sold by a dealer to another dealer, the sales price of the vehicle likely should be excluded as it reflects a dealer-to-dealer trade rather than a retail transaction between a dealer and a consumer. As another example, if a vehicle is involved in a fleet transaction, the sales price of the vehicle likely should also be excluded. This is further explained below with reference to Table 10 shown in FIG. 15. Note that the steps of method 400 may be performed in different orders and are not limited to the order shown in FIG. 4. This is further illustrated in an embodiment shown in FIGS. 5A-5B.

The resulting data can be collated and stored (step 416). As described above, responsive to a request from a dealer, various pieces of information from the stored data can be fetched and displayed in a dealer-facing custom user interface (step 418).

Those skilled in the art will appreciate that not all of the steps described above with reference to FIG. 4 may be required and that various steps not shown in FIG. 4 may be added. As an example, FIGS. 5A-5B depict a flow diagram illustrating in detail how a sales analyzer method may implement an embodiment of method 400. For illustrative purposes, numerical examples of sales analyzer method 500 are provided in Tables 1-10 shown in FIGS. 6-15.

Specifically, Table 1 of FIG. 6 shows one example of the initial state of raw vehicle sales data received at or otherwise obtained by an embodiment of a system disclosed herein (e.g., vehicle data system 220 of FIG. 2). As described above, the system may normalize and store the vehicle sales data in a data store (e.g., data store 222 of FIG. 2). Accordingly, in some embodiments, sales analyzer method 500 may begin with vehicle transactions stored in a database (501).

Notice some fields of Table 1 have zero values or are missing values. In some embodiments, the system may process the vehicle transactions (503) and flag any one that does not have a Vehicle Identification Number (VIN) (513). As explained below, the VIN can be useful in obtaining additional information pertaining to the particular vehicle associated therewith. Thus, a vehicle transaction record that does not have a VIN may be identified and flagged by the system. Flagging the vehicle transaction record may trigger a review and/or a process to obtain the missing VIN for the vehicle transaction record. Further, the system may skip processing vehicle transaction records that do not have VINs. In the example of Table 1, every vehicle transaction record is assumed to have a VIN.

From here, the system may determine the most recent transaction(s) per dealer and/or VIN (505). Since the database is continually updated (e.g., daily), this allows the system to selectively process recent vehicle transaction records without needing to process the entire database.

For each transaction, the system may perform a plurality of checks, including determining whether the transaction has a trim identification code (Trim-ID) (507), determining whether the transaction has a valid Manufacturer Suggested Retail Price (MSRP) (510), or determining whether the transaction has a valid invoice price, etc. (512). Those skilled in the art will appreciate that the system may perform these checks in an order that is different than the example shown in FIGS. 5A-5B.

In the context of this disclosure, a vehicle's trim may refer to a configuration of standard equipment, options or amenities. For example, a base trim may have standard features such as manual transmission, standard wheel covers and/or cloth seats. Whereas, a higher end trim may include automatic transmission alloy wheels, leather upholstery and/or air conditioning. Varying a vehicle's trim allows manufacturers of vehicles to produce vehicles that target different market niches. Generally, vehicle manufactures may provide lookup tables for a vehicle's VIN, using character code to indicate a distinct year, make, model and body type (YMBB) of the vehicle. Additionally, vehicle manufacturers may utilize a trim identification code to represent a trim of a particular vehicle. Such a trim identification code may encompass the year, make, model, and body type information particular to the vehicle. However, due to the standardized vehicle identification numbering system, vehicle manufacturers may not establish, create or form the more accurate or precise mapping of the trim identification code of a vehicle within the vehicle's VIN. Thus, for many vehicle manufacturers, vehicle variations below the YMMB level may not be determined based on a vehicle's VIN alone. To get additional information pertaining to a VIN at the trim level, a VIN decoder such as one described in U.S. Pat. No. 8,661,020 may be utilized.

Accordingly, if the system determines that a recently received or obtained vehicle transaction record does not have a trim identification code, the system may run a VIN decoder to decode the VIN in the vehicle transaction record and get trim level data (509). For example, the VIN decoder may determine a probability of match indicating how likely this is the correct trim. The system may append the probability of match (see e.g., “match_probability” of Table 3 shown in FIG. 8) and use the decoded trim identification code to populate other fields (e.g., “trim_year,” “trim_make,” “trim_model,” “trim_style,” “base_msrp,” “base_invoice,” etc. by looking up these values from other internally stored tables). If the VIN cannot be decoded (e.g., as indicated by a message from the VIN decoder), the system may flag the vehicle transaction record, indicating that a trim identification code cannot be found or determined (513). In the example of Table 1, vehicle transaction records that do not have a valid trim identification code are marked “0” in the column “is_valid_trim”; whereas a vehicle transaction record that has a valid trim identification code “263758” is marked “1” in the “is_valid_trim” column.

In the example of method 500, the system may perform additional checks such as determining whether the transaction associated with the vehicle transaction record has a valid MSRP (510). If not, the system may attempt to obtain the MSRP (520), for instance, by querying another database or data source storing listings and/or inventory associated with the dealer. The system may determine whether the MSRP thus obtained (inventory MSRP or listing MSRP) is valid (522). If not, the system may attempt to impute the obtained MSRP (530) and determine whether the imputed MSRP is valid (532). If the imputed MSRP is valid, the system may flag it accordingly (534). Otherwise, the system may flag it for exclusion (535).

Table 2 of FIG. 7 shows how the listing/inventory MSRP prices can be added or appended to the raw data shown in Table 1 of FIG. 6. In this example, a new column “inv_msrp” is appended to Table 1. The result is shown in Table 2 (see column 701). To the extent that they are available, the listing/inventory MSRP prices may be received or obtained by the system and added to column 701 “inv_msrp”.

The system may perform a similar check for invoice price. For example, the system may determine whether the transaction associated with the vehicle transaction record has a valid invoice price (512). If not, the system may attempt to impute the invoice price (514) and determine whether the imputed invoice price is valid (516). If the imputed invoice price is valid, the system may flag it accordingly (518). Otherwise, the system may flag it for exclusion (535).

As illustrated in Tables 1 and 2, dealer transaction data provided by dealers may not be complete. Some may be missing a trim identification code which is used by the system to look up internal information (internal to the system) such as the total amount of options, price relative to market, etc. As described above, if a trim identification code is found or can be determined for a vehicle transaction record, the system may use the trim identification code to obtain additional trim-level supplemental data (e.g., from internally stored look up tables) and append them to Table 2 (or Table 1, depending upon whether the MSRP check is performed before or after the Trim-ID check). An example of the result is shown in Table 3 of FIG. 8. In this example, new columns 801 are created and, where available, the decoded trim identification codes are inserted into the corresponding fields of the vehicle transaction records being processed by the system. As the invoice price and dealer cost fields of vehicle transaction data received or obtained from external data source(s) may be inaccurate, the presence of accurate trim information or option information may be leveraged to determine the actual invoice price and/or dealer cost.

Now that accurate trim mapping and identifiable option information has been obtained, an MSRP may be determined for each of the vehicle transactions. Given that vehicle transaction data received or obtained from external data source(s) may be unreliable, it may be desirable to determine certain data associated with the vehicle transaction data utilizing known data. Thus, even if an MSRP was provided or otherwise obtained, an MSRP for a vehicle transaction may be determined. First, a base MSRP may be determined. Specifically, with year, make, model, and trim identified specifically from the VIN, a base MSRP may be determined based on data provided by a data source. Then, using additional options identified by the vehicle transaction data, the manufacturer suggested retail pricing for these options can be added to the base MSRP to form a vehicle transaction MSRP. More specifically, with each vehicle transaction, there may be a field that includes a set of options codes indicating which options were factory-installed on the particular vehicle corresponding to that historical transaction. Parsing this information, the options codes can be used in conjunction with option pricing information obtained from a data source to identify a MSRP for each factory-installed option. Summing each of the manufacturer prices for the options the Total Options MSRP can be generated and added to the base MSRP to generate the transaction MSRP for that particular vehicle transaction (Vehicle Transaction MSRP=Base MSRP+Total Options MSRP).

After a transaction MSRP is determined, a corresponding transaction invoice price can be determined. The transaction invoice price may be generated similarly to the transaction MSRP described above. First, a base Invoice price may be determined. Specifically, with year, make, model, and trim identified specifically from the VIN, a base invoice price may be determined based on data provided by a data source. Then, using additional options identified by the vehicle transaction data, pricing for these options can be added to the base invoice price to form the transaction invoice price. More specifically, with each vehicle transaction, there may be a field that includes a set of options codes indicating which options were factory-installed on the particular vehicle corresponding to that vehicle transaction. Parsing this information, the options codes can be used in conjunction with option pricing information to assign an options invoice price for each factory-installed option. Summing each of the option invoice prices for the options the Total Options Invoice price can be generated and added to the base invoice price to generate the transaction invoice price for that particular vehicle transaction (Transaction Invoice=Base Invoice+Total Options Invoice).

Using the determined MSRP and invoice price, a dealer cost may be determined. This dealer cost may be determined algorithmically utilizing a dealer cost model associated with the manufacturer of the vehicle associated with a vehicle transaction. As described above, the system may have access to dealer cost models stored in models 128. Using the holdback equation corresponding to the make of the vehicle to which the vehicle transaction pertains, the base invoice price, base MSRP, transaction invoice price and transaction MSRP determined for that vehicle transaction, and freight fees (which may be determined based on information obtained from a data source similarly to the determination of base invoice and base MSRP), the holdback equation can be applied to determine dealer cost (e.g., dealer cost=invoice−holdback).

Thus, running a VIN decoder can generate additional trim-level supplemental data (see Table 3). If desired, the trim-level supplemental data can also be used to compute and/or impute (simple calculation) additional data points, for instance, by incremental options, subtraction, multiplication, etc. For example, the system may determine a ratio of the base MSRP (e.g., $32,395) over the base invoice price (e.g., $30,792) for a particular trim (e.g., Trim-ID “266016”) as 1.05205898 and a ratio of the base invoice price over the base MSRP as 0.95051706. These and other imputed values are appended via new columns 901, as shown in Table 4 of FIG. 9.

In the example of Table 4 shown in FIG. 9:
“r_vehicle_msrp_invoice” refers to the ratio of base vehicle MSRP to invoice (i.e., MSRP/Invoice). This ratio can be pre-computed from a table of MSRP and invoice values at the vehicle trim level.
“r_opt_msrp_invoice” refers to the average ratio of options MSRP to invoice (i.e., Avg(MSRP_option/invoice_option). This ratio can be pre-computed from a table of options pricing.
“r_vehicle_invoice_msrp” refers to the inverse ratio from “r_vehicle_msrp_invoice” (i.e., Invoice/MSRP).
“r_opt_invoice_msrp” refers to the inverse ratio from “r_opt_msrp_invoice” (i.e., Avg(Invoice_option/MSRP_option).
“Options_msrp=MAX(0, msrp−base_msrp). Note that “base_msrp” may exist only when a VIN can be decoded successfully.
“Options_invoice=MAX(0, invoice−base_invoice). Again, “base_invoice” may exist only when a VIN can be decoded successfully.

Because the system can compute and/or impute options MSRP and option invoice prices, the listing/inventory MSRP can be adjusted, to the extent possible, to reflect more accurately the option(s) associated with a vehicle. That is, the system can utilize the imputed values in columns 901 to impute adjusted values. The imputed adjustments are appended via new columns 1001, as shown in Table 5 of FIG. 10.

In the example of Table 5 shown in FIG. 10:
“r_imputed_msrp” can be determined as follows: If the system has a valid MSRP, that value is used. Otherwise, if the system has all the necessary values, it computes r_imputed_msrp=base_msrp+options_invoice*r_opt_msrp_invoice. The “base_msrp” field is shown in Table 3 of FIG. 8. The “options_invoice” and “r_opt_msrp_invoice” fields are shown in Table 4 of FIG. 9. As an example, for the Kia Sorento (third row), r_imputed_msrp=32395+375*1.08=32800.
“r_imputed_invoice” can be determined as follows: If the system has a valid invoice, that value is used. Otherwise, if the system has all the necessary values, it computes r_imputed_invoice=base_invoice+options_msrp*r_opt_invoice_msrp. As an example, for the Kia Sorento (third row), r_imputed_invoice=invoice=31167.
The final msrp value “configured_msrp” in Table 5 can be determined as follows: If the system has a valid transaction MSRP (“msrp”), that value is used. Otherwise, if the system has a valid inventory MSRP (“inv_msrp”), that value is used. Else, if the system has a valid imputed MSRP (r_imputed_msrp), that value is used. Otherwise, NULL is used. As an example, for the Kia Sorento (third row), configured_msrp=inv_msrp=31865.
The “msrp_is_imputed” flag is set if the system uses any value other than the transaction MSRP “msrp”.
The final invoice price value “configured_invoice” in Table 5 can be determined as follows: If the system has a valid transaction invoice (“invoice”), that value is used. Otherwise, if the system has a valid imputed invoice (“r_imputed_invoice”), that value is used. Else, NULL is used. As an example, for the Kia Sorento (third row), configured_invoice=invoice=31167.
The “invoice_is_imputed” flag is set if the system uses a value other than the transaction invoice (“invoice”). In the example of the Kia Sorento, since the transaction invoice value of 3116 is used, the “invoice_is_imputed” flag is not set.
The “has_price_msrp” flag is set if the system has a valid MSRP and transaction price (“sales_price”). In the example of the Kia Sorento, the system now has a valid imputed MSRP and transaction price. Thus, the “has_price_msrp” flag is set.

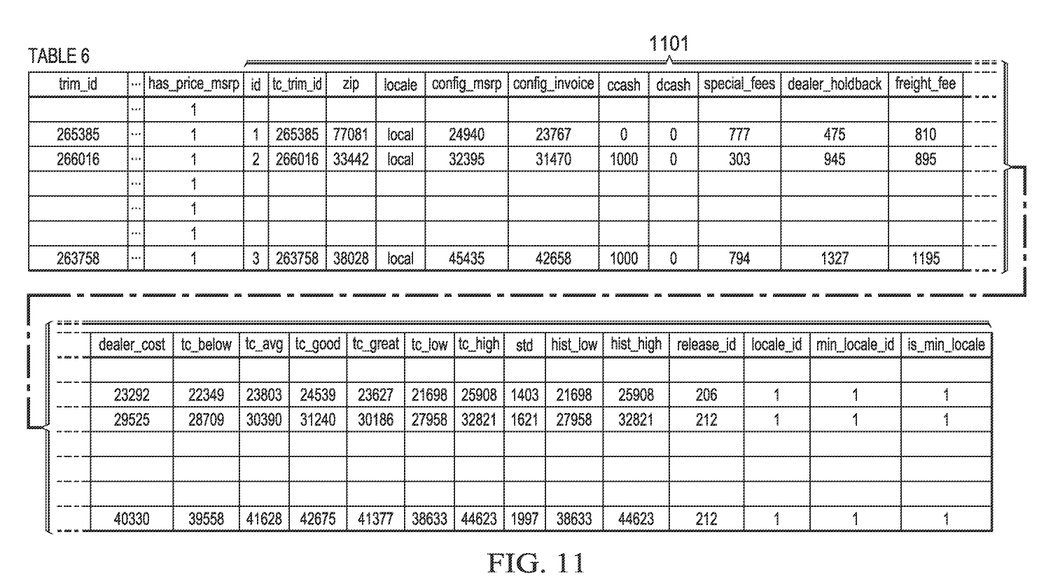

At this point, the system has sufficient reference pricing data points to compute internal vehicle pricing data (540) that can be used by the system to later generate a dealer-facing custom user interface. In some embodiments, this may entail the system running a vehicle pricing algorithm implemented in a pricing model, such as dealer cost or price ratio models described in the above-referenced U.S. Patent Application Publication No. US 2010/0070343 A1 or a geo-specific price estimation model described in the above-referenced U.S. Patent Application Publication No. US 2013/0006876 A1. The computed vehicle pricing data are appended via new columns 1101, as shown in Table 6 of FIG. 11. In the example of Table 6, columns 1101 may include a plurality of computed vehicle prices, including quantifiable prices or price ranges (e.g., transaction MSRP “config_msrp,” transaction invoice price “config_invoice,” dealer hold back “dealer_holdback,” freight fee “freight_fee,” dealer cost “dealer_cost,” below market average price “tc_below,” market average price “tc_avg,” good price “tc_good,” great price “tc_great,” low price “tc_low,” high price “tc_high,” standard deviation “std,” historical low price “hist_low,” historical high price “hist_high,” etc.) as well as identification fields (e.g., system identifier “id,” trim identification code “Trim_ID,” geographic identifier “zip,” locality identifier “locale,” etc.), and flag fields (e.g., “locale_id,” “min_locale_id,” is_min_locale, etc.). As those skilled in the art will appreciate, Table 6 now includes not only dealer-specific data, but also general sales data relative to the market where the dealer is located.

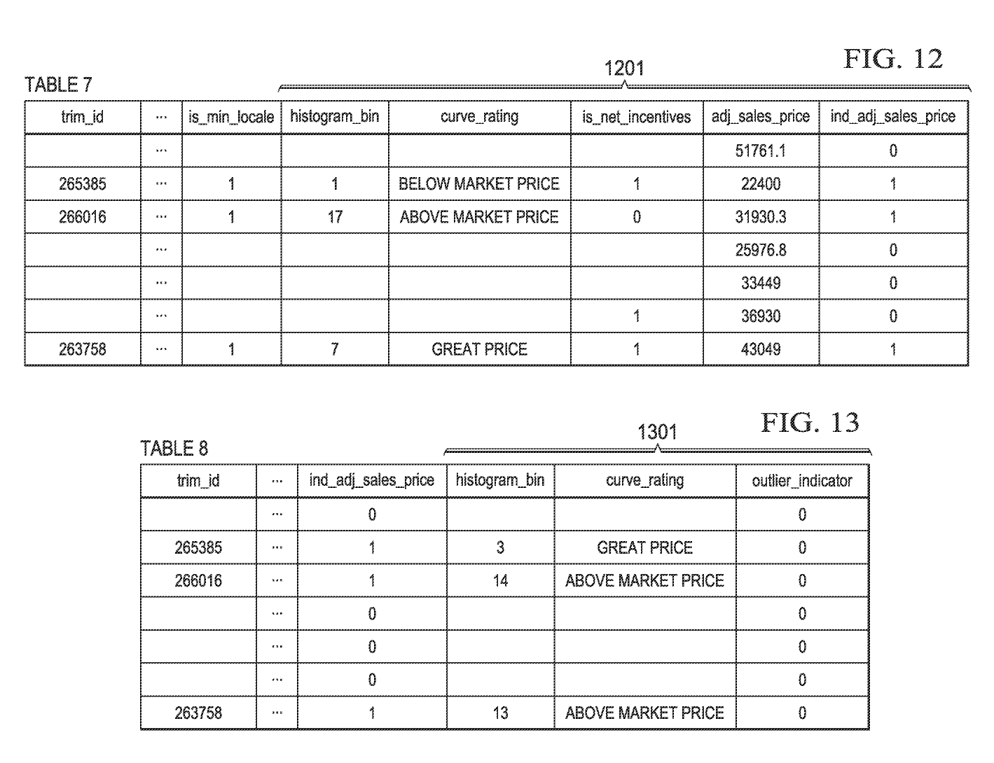

In some embodiments, the computed vehicle pricing data may be adjusted to reflect applicable incentives (542). Corresponding price ratings (e.g., “below market price,” “above market price,” “great price,” etc.) and histogram bins may also be determined. Flag(s) may be included to indicate whether a net incentive is applicable (e.g., “is_net_incentives”) or whether the sales price has been adjusted (e.g., “ind_adj_sales_price”). An example is shown in Table 7 of FIG. 12, where adjusted sales prices, price ratings, histogram bins, and flags are appended via new columns 1201.

Notice the adjusted sales price for a vehicle trim identified as “263758” is shown as a “Great Price” in Table 7. However, comparing with the determined vehicle pricing which more accurately reflects the relevant vehicle market, the true dealer pricing was actually above the market price (e.g., the adjusted sales price of $43,049 by the particular dealer is actually above the internally determined average sales price (or price range) of $41,628, as shown in column “tc_avg” of Table 6 of FIG. 11). Accordingly, the system may normalize the price ratings and histogram bins relative to the internally determined vehicle pricing data and append the normalized price ratings and histogram bins via new columns 1301, as shown in Table 8 of FIG. 13.

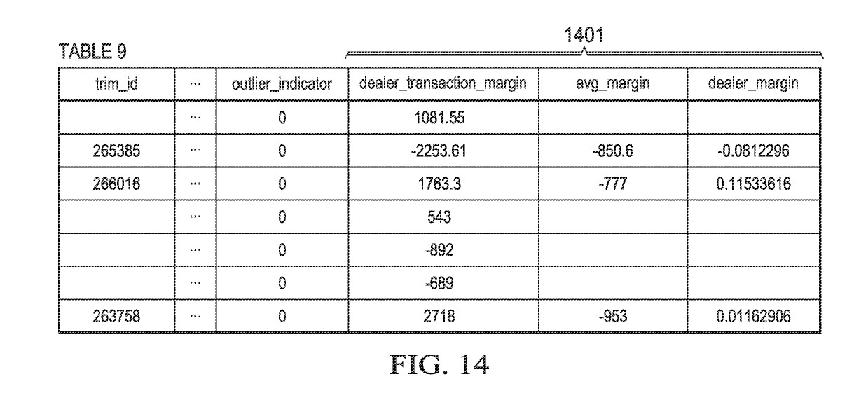

The system may further determine whether a vehicle transaction has a price margin associated therewith (544). If not, based on available data so far, price margins for the transaction may be computed/imputed (546) and appended via new columns 1401, as shown in Table 9 of FIG. 14. As discussed above, price margins may be determined using a geo-specific price estimation model disclosed in U.S. Patent Application Publication No. US 2013/0006876 A1. In some embodiments, the system may leverage the “front_end_gross_profit” field (see Table 1 of FIG. 6) and use a value from a corresponding “front_end_gross_profit” field for the “dealer_transaction_margin” field such that dealer_transaction_margin=front_end_gross_profit. If the gross profit field is null (e.g., as in the case of the Kia Sorento in the third row of Table 1 shown in FIG. 6), the system may construct front_end_gross_profit=sales_price−sales_cost. For example, referring to Table 1 shown in FIG. 6, the frontend gross profit for the Kia Sorento=sales_price−invoice=32930.3−31167=1763.3. This value is then used as a dealer_transaction_margin value for the Kia Sorento (third row), as shown in Table 9 of FIG. 14. If cost is missing (e.g., as in the case of the Ford F-150 in the last row of Table 1 shown in FIG. 6), the system may proceed to fill in as follows: gross profit=sales_price+total_rebate_amount−config_invoice+dealer_holdback=40799+3250−42658+1327=2718. This value is then used as a “dealer_transaction_margin” value for the Ford F-150 (last row), as shown in Table 9 of FIG. 14. Note that the “config_invoice” value of 42658 comes from the “config_invoice” field (see Table 6 shown in FIG. 11), which is different from the original invoice and is calculated as config_invoice=invoice+special_fees=41863.9+794=42657.9 (which is rounded up to 42658). The “dealer_holdback” and “special_fees” fields are also shown in Table 6 of FIG. 11.

Referring to Table 9 of FIG. 14, the system may determine a value for the “avg_margin” field as follows:
If sales cost is available, avg_margin=tc_avg−sales_cost−total_rebate_amount. The “tc_avg” field is shown in Table 6 of FIG. 11. The “sales_cost” and “total_rebate_amount” fields are shown in Table 1 of FIG. 6. For example, for the Toyota Camry (second row), avg_margin=23803−23653.6−1000=−850.6, as shown in Table 9 of FIG. 14.
If sales cost is not available, avg_margin=tc_avg−dealer_cost+ccash−total_rebate_amount. The “dealer_cost” and “ccash” fields are shown in Table 6 of FIG. 11. For example, for the Ford F-150 (last row), avg_margin=41628−40331+1000−3250=−953, as shown in Table 9 of FIG. 14. Note that dealer_cost=config_invoice−dcash−dealer_holdback−ccash=42658−0−1327−1000=40331. As discussed above, market average price “tc_avg” and other modeled market averages may be determined using dealer cost models and price ratio models described in the above-referenced U.S. Patent Application Publication No. US 2010/0070343 A1.

In some embodiments, the system may determine a “dealer_margin” value as follows:

Dealer_margin=(sales_price−dealer_cost)/dealer_cost. The “sales_price” field is shown in Table 1 of FIG. 6 and the “dealer_cost” field is shown in Table 6 of FIG. 11. For example, for the Toyota Camry (second row), dealer_margin=(21400−23292)/23292=−0.0812296, as shown in Table 9 of FIG. 14.

Referring to FIG. 5, the system may determine whether an imputed margin is valid (548). If so, the imputed margin may be flagged (550). Otherwise, the transaction may be flagged (535).

In some cases, exclusion flags may be computed. For example, the system may determine whether a vehicle transaction is actually a dealer trade (552) and, if so, flags it accordingly (554). Moreover, the system may determine whether a vehicle transaction is actually a fleet transaction (556) and, if so, flags it accordingly (552). The system may further detect and flag outliers for exclusion (558). These flags are appended via new columns 1501, as shown in Table 10 of FIG. 15. In some embodiments, this can be a rule-based analysis. For example, a rule may specify a plurality of categories for excluding or imputing a vehicle transaction. As a specific example, a category “[0]” may indicate that a vehicle transaction is excluded because one or more required fields are missing or cannot be imputed, a category “[1]” may indicate that a vehicle transaction is excluded because one or more values are outside (above or below) of an expected range, a category “[2]” may indicate that a vehicle transaction is excluded because it is a dealer trade or a wholesale, and a category “[3]” may indicate that a vehicle transaction is imputed because one or more fields were imputed during process. Additionally, a plurality of rules may specify particular exclusion reasons (e.g., exclusion reason code “[6]” may indicate that the sales price/MSRP ratio is outside of an expected range) and particular imputation reasons (e.g., imputation reason code “[9]” may indicate that the sales price is imputed). As illustrated in Table 10, these rules may be applied independently in that a vehicle transaction can be both imputed and excluded. If the system determines that a vehicle transaction should be discarded, a flag is correspondingly set, as shown in Table 10.

At display time, the system may handle exclusions and imputations differently (560). For example, imputed values (referred to as imputations) may be displayed with flags to a request user via a dealer-facing customer user interface (562); while excluded values (referred to as exclusions) may be displayed, but not used in generating a visual presentation such as a curve and/or histograms on dealer-facing customer user interface (566). If no imputations or exclusions apply, the system may proceed to display the results from method 500 on the dealer-facing customer user interface using data from Table 10, which includes all of Tables 1-9.

As a specific example, referring to FIG. 2, suppose a vehicle transaction record associated with a dealer (e.g., identified by an external dealer identifier “FL15793,” see Table 1 shown in FIG. 6) in sales data 223 is missing the MSRP value. The VIN is looked up in the inventory records stored in vehicle data 225, and the MSRP is found there ($31,865), is found to be within an appropriate range for the transaction (compared to the transaction price of $32,930, see “sales_price” of Table 1, FIG. 6), and is appended to the incoming record (see “inv_msrp” of Table 2, FIG. 7).

The transaction data is used to determine the equivalent market distribution of prices. As described above, these prices may be unique to an embodiment of a system disclosed herein. In this example, the transaction price of $32,930 is found to be significantly above the market average value of $30,390 (see “tc_avg” of Table 6 shown in FIG. 11); the transaction has no associated rebate amount (see “total_rebate_amount” of Table 1 shown in FIG. 6) and no dealer cash incentive (“see “dcash” of Table 6 shown in FIG. 11), but does have $1,000 in publicly available Customer Cash Rebates (see column “ccash” of Table 6 of FIG. 11). The transaction price of $32,930 is reduced by $1,000, to $31,930, in order to make it equivalent to the market pricing, which includes the $1,000 in publicly available Customer Cash Rebates.

The adjusted transaction price of $31,930 (see “adj_sales_price” of Table 7 shown in FIG. 12) is then compared to the equivalent market distribution to determine a true price rating. Due to the adjustment made to reflect the Customer Cash Rebates, the adjusted transaction price is flagged as having been imputed (see e.g., the corresponding “ind_adj_sales_price” field for the transaction at issue has a value of “1”). As describe above, a dealer-facing custom user interface may be adjusted accordingly to call out this fact.

In this way, the system can build a comprehensive “big data” database for each dealer affiliated or registered with the system relative to their vehicle sales transactions. As those skilled in the art will appreciate, such a comprehensive vehicle sales transactions database can include all transaction records provided by a dealer (which can include the particular dealer's pricing information, sales people, transaction dates, specific vehicles transacted, inventory data, etc.), all sales data collected (received or obtained) from external sources across various dealers (perhaps in the same geographic region or locale as the particular dealer), and all internally computed vehicle pricing data points (which can include those specific to the vehicle and/or the vehicle transaction such as options MSRP, incentives, freight fee, dealer holdback, etc. and quantifiable prices or price ranges such as “average,” “good,” “great,” “overpriced,” etc. determined by applying certain pricing model or models to anonymized historical transactions). As described above, the system can continuously update the database by running the above-described analytics (e.g., at a predetermined time interval such as daily) and storing the results for use in generating dealer-facing custom user interfaces at request time.

In some embodiments, the system may generate a dealer-facing custom user interface with various filters to allow a dealer user better visualize and understand how their vehicle prices compare to the market at large, receive recommendations on possible adjustments to improve margins or sales velocity, and better understand where their customers come from in order to optimize marketing spend towards the most desirable customers. The following is a non-exclusive list of potential displays that may be generated using embodiments disclosed herein:
Sales counts
   Map-level geographic (zip code) display
   Vehicle model level display
   Salesperson displays
Average Profit Margins
   Map-level geographic (zip code) display
   Vehicle model level display
   Salesperson displays
Pricing Bands
   “Price Curve” display relative to local market
Vehicle Supply vs Demand
   Day's Supply
   Average Days to Turn
   Demand
   Type (trim, model, body-style)
   Color
   Model year
   Supply
   Type (trim, model, body-style)
   Color
   Model year
   Demand vs. Supply
Market share
   Map-level geographic (zip code) display
   Vehicle model level display

In some embodiments, users can leverage a variety of global and contextual filters to apply to their transactions. Examples of such filters may include, but are not limited to:
Make/Model
[x] miles away from my dealership
Specific price ranges
Salesperson
Front-End Margin

In some embodiments, the system can be configured to allow users to export data in a variety of formats for further offline analysis.

In some embodiments, the system can be configured to provide summaries with insights, for example:
Top/bottom three models by margin
Top/bottom performing geographic areas
Top/bottom performing salespeople

In some embodiments, the system can be configured to determine and present trends over time, for instance, margin trends over the last six months by specific models, fastest growing sales areas, etc.

In some embodiments, the system can be configured to provide and visualize demographic data such that users can understand more about their customers.

In some embodiments, the system can be configured to make recommendations on opportunities to improve margins or move more products.

In some embodiments, users can leverage pre-existing filter configurations, or create and save new ones for use in future sessions.

Referring to FIG. 2, vehicle data system 220 may receive a request from a user (e.g., a store owner, an internet sales manager, etc. representing a dealer) at a particular location requesting sales information about the dealer. The user may log into vehicle data system 220 via a standard permission model in which permissions may be granted based on roles. For instance, the store owner, internet sales manager, etc. may have different permission levels. Other security measures may also be implemented. User permission models are known to those skilled in the art and thus are not further described herein.

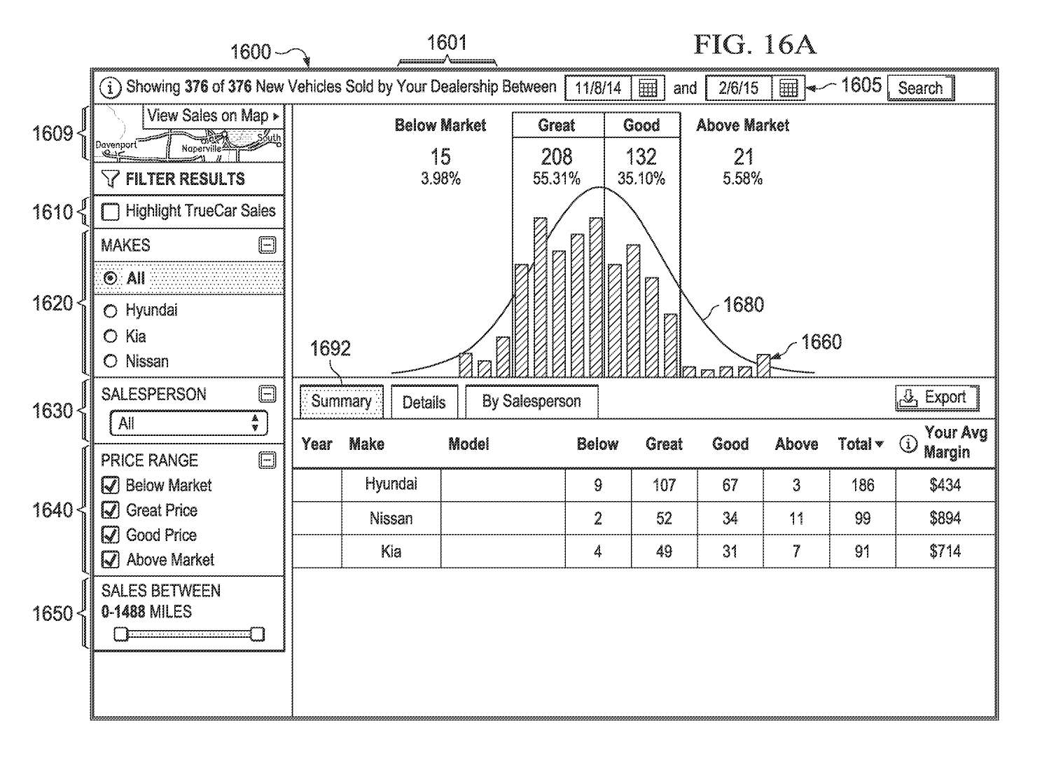

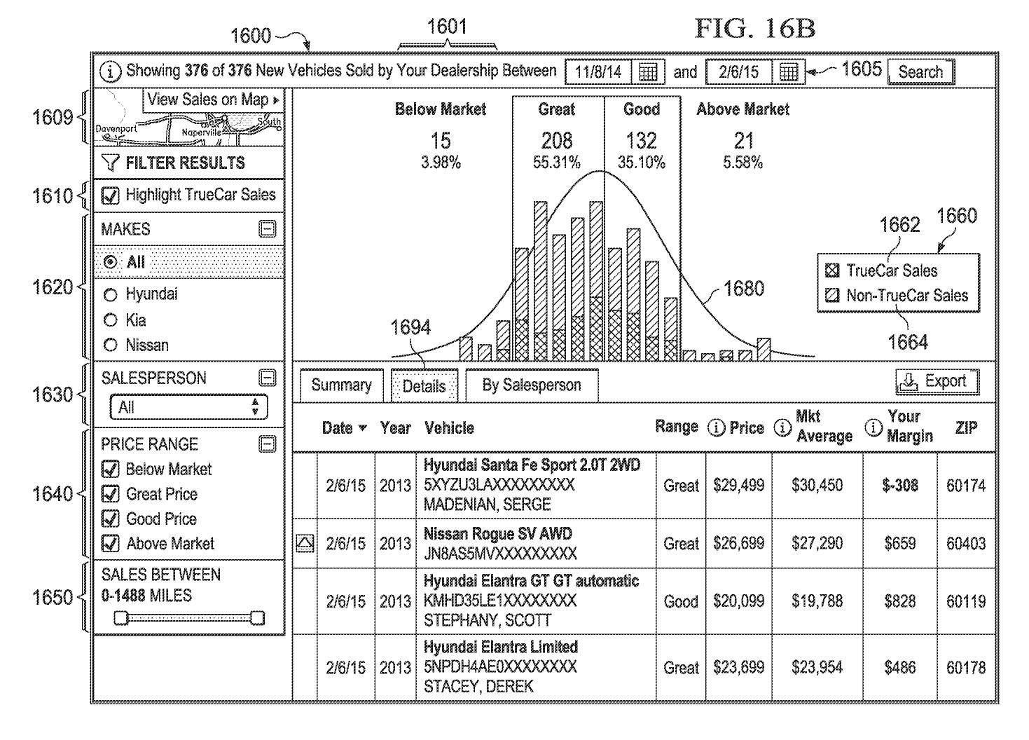

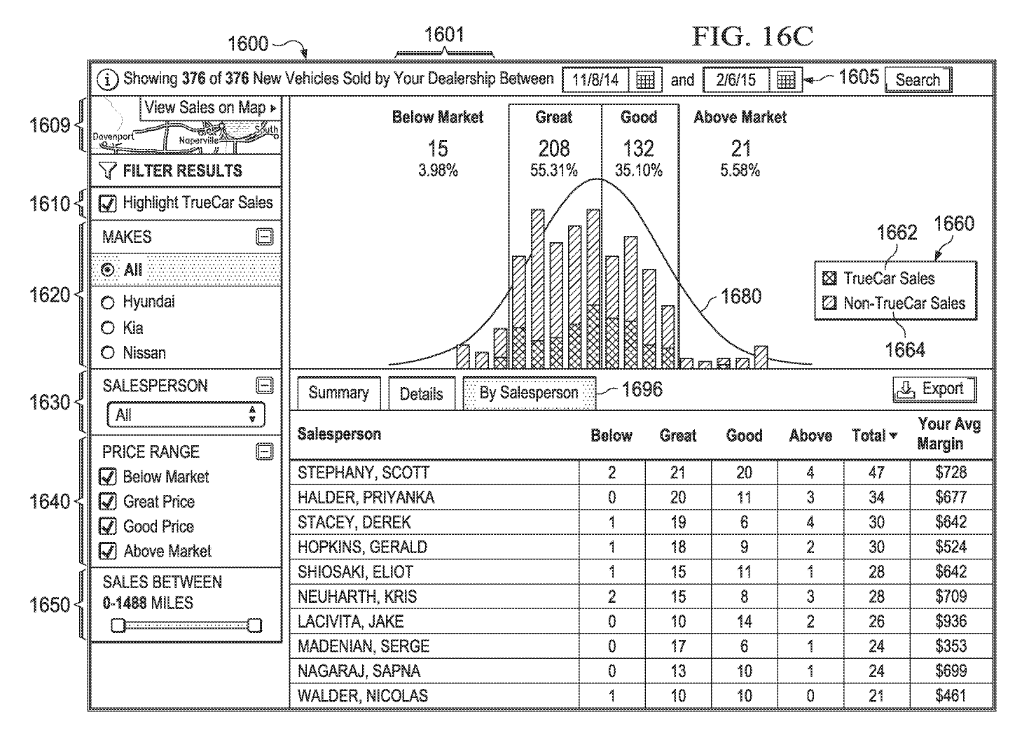

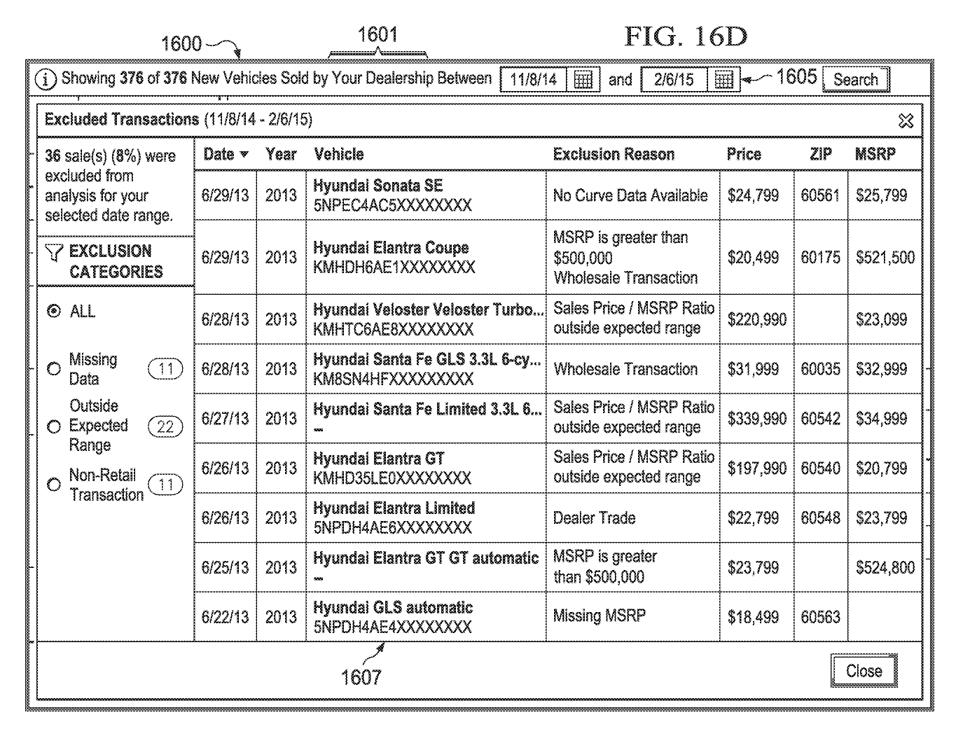

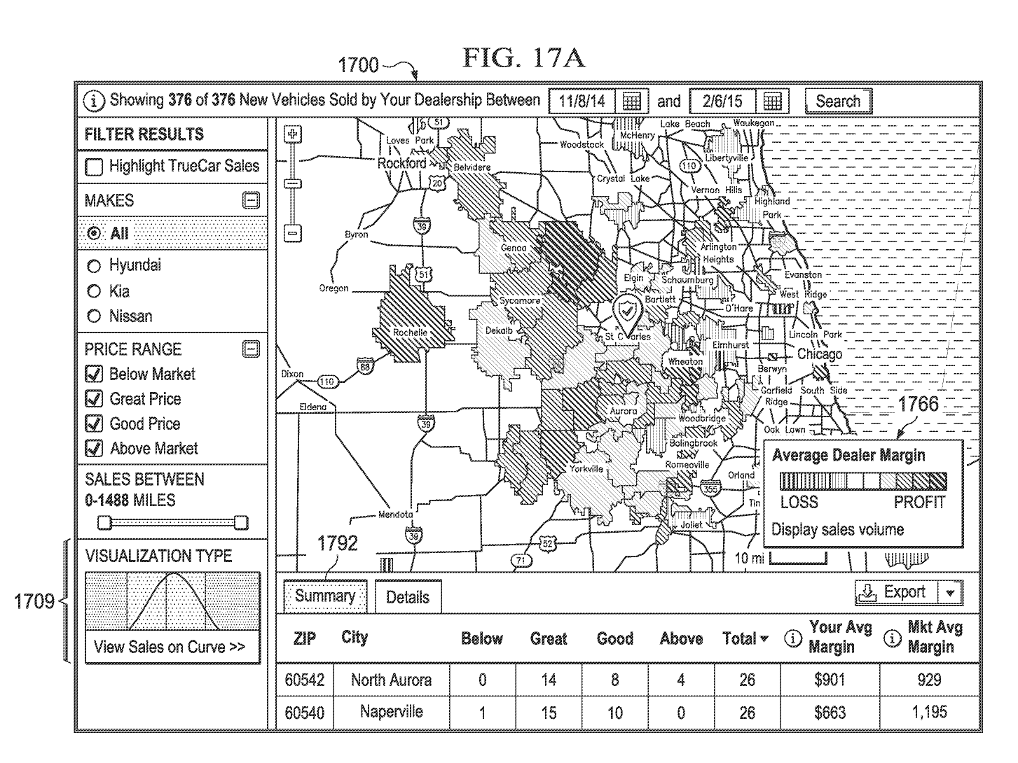

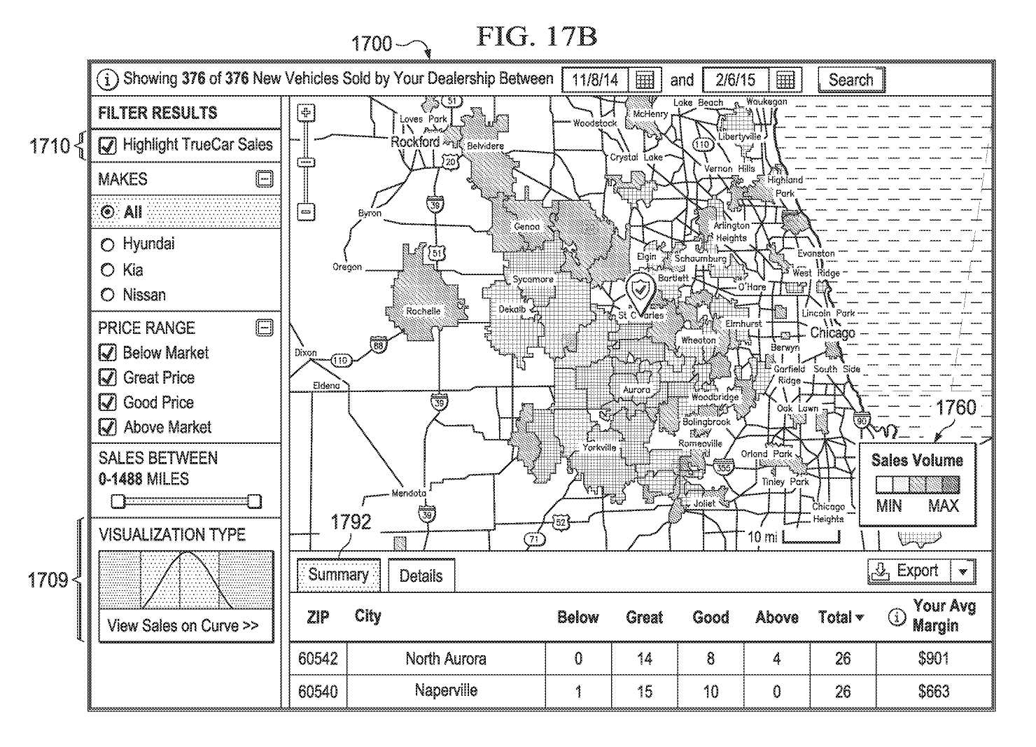

In response, processing module 296 may access data store 222 to retrieve the dealer's comprehensive database from vehicle data 225 using parameters (e.g., dealer credential, locale, etc.) from the request. As described above, vehicle data system 220 may continuously update the dealer's comprehensive database such that it already has the most recent dealer-specific transaction records and up-to-date general sales data including vehicle prices and price ranges and corresponding curve ratings and histograms. For example, dealer transaction data 234 may come in on a nightly basis. Vehicle data system 220 may analyze dealer transaction data 234 to determine where it falls (e.g., which price ranges), append to it, compute internal vehicle pricing data, and store the new and/or updated data points in vehicle data 225. Accordingly, processing module 296 may call dealer interface module 292 with data from the dealer's comprehensive database. Dealer interface module 292 may, in turn, generate a user interface (referred to as a dealer portal) particularly customized for the dealer. Examples of a dealer portal are shown in FIGS. 16A-17B.

As illustrated in FIGS. 16A-16D, dealer portal 1600 is particularly customized for dealer 1601 and may only show information specific to dealer 1600, including every single transaction, sales person, transaction date, specific vehicle transacted, inventory data, etc. Although dealer portal 1600 may show aggregated summaries for other dealers at the local level, no identifiable information relating to other dealers is shown. In the example of FIG. 16A, the user can see how their new vehicle sales prices relative to their local market within selected time period 1605. Dealer portal 1600 includes a plurality of filters including visualization type filter 1609, special sales filter 1610, makes filter 1620, salesperson filter 1630, price range filter 1640, and geographical boundary filter 1650.

In the example of FIG. 16A, all transactions of dealer 1601 in time period 1605 are considered in generating summary 1692. Specifically, special sales filter 1610 is unchecked, a mix of makes is selected via makes filter 1620, all salespeople are selected via salesperson filter 1630, all price ranges are selected via price range filter 1640, and a geographical boundary is defined to be sufficiently large such that all transactions of dealer 1601 in time period 1605 would be included. In this case, the specific transactions of dealer 1601 are displayed (in summary 1692 and histogram 1660) relative to the general sales data (in summary 1692 and curve 1680). That is, individual histogram bars 1660 are associated with specific dealer 1601 and overall curve 1680 is associated with other dealers in the area. For example, in period 1605, dealer 1601 has 132 transactions within 1488 miles having vehicle sales prices that are in the “good” price range of curve 1680, of which 67 were Hyundai, 34 were Nissan, and 31 were Kia. In this example, summary 1692 also shows average margins which, as described above, may be determined using a geo-specific price estimation model.

Details of the specific transactions of dealer 1601 can also be retrieved and displayed, for instance, in details 1694 of FIG. 16B. FIG. 16B further illustrates that, when special sales filter 1610 is selected, dealer portal 1600 may generate an overlay such that histogram 1660 shows both special sales 1662 and other sales 1664. In the context of this disclosure, special sales may refer to those transactions where a proprietary sales certificate specifying an upfront, non-haggle price is used.

Details of the specific transactions of dealer 1601 can also be further drilled down to individual salespeople and displayed, for instance, in details 1696 of FIG. 16C. For example, as described above, dealer 1601 has 132 sales transactions within 1488 miles in time period 1605 having vehicle sales prices that are in the “good” price range of curve 1680. Of the 132 “good” sales, 20 were handled by salesperson “Scott” out of a total of 47 transactions handled by him during time period 1605. Dealer portal 1600 may also display the average margin for the 47 transactions handled for dealer 1601 by this salesperson, as well as the average margins for the transactions handled for dealer 1601 by other salespeople such that the user can readily compare the performances of all the salespeople associated with dealer 1601.

As described above, in some embodiments, the system may display exclusions (excluded transactions) determined by the analytics. FIG. 16D illustrates, in time period 1605, 36 sales of dealer 1601 were excluded from analysis. In this example, the system further provides exclusion reasons 1607 in dealer portal 1600. Exclusion reasons 1607 may correspond to exclusion reason codes described above with reference to Table 10 shown in FIG. 15.

Through visualization type filter 1609 of dealer portal 1600, dealer 1601 choose a different visualization type which may allow dealer 1601 to analyze their sales geographically to better understand where their customers come from. This is illustrated in FIGS. 17A-17B.

FIG. 17A depicts a diagrammatic representation of dealer portal 1700. Unlike dealer portal 1600, summary 1792 shows sales transactions of a dealer relative to geographic regions or areas (e.g., by zip code, city, etc.). Like dealer portal 1600, dealer portal 1700 provides visualization type filter 1709. Responsive to selection of visualization type filter 1709, the system can transition to dealer portal 1600. Likewise, responsive to selection of visualization type filter 1609, the system can transition to dealer portal 1700.

Displaying sales volume relative to average dealer margins on map 1766 allows a dealer to analyze their margins to understand how they perform geographically. Again, like dealer portal 1600, dealer portal 1700 may include a plurality of filters, including special sales filter 1710, as shown in FIG. 17B. When selected, the system can transition to map 1760, showing how special sales perform geographically

Other implementations of a custom user interface may also be possible. For example, a custom user interface may be generated with additional filters such as date, year, vehicle, price range, market average, market margin, zip code, along with a dealer's margins to allow the dealer to analyze how their margins compare against their local markets.

The invention disclosed herein can have many uses. For example, the invention can be implemented as an inventory optimizer to help isolate opportunity for dealers by investigating demand for vehicles with specific attributes (color and/or options) and compare this with local inventory. When normalized to an index, an embodiment of a system disclosed herein can identify over- and under-supply.

An example embodiment of an inventory optimizer is illustrated with reference to Table 11 below.

TABLE 11

| | Feature | | | | | | | | | |
|---|---|---|---|---|---|---|---|---|---|---|
| | | | Supply (within | | | | | | Indexed | |
| | Demand | | N mi of demand) | | Demand − Supply | | Demand/Supply | | Demand/Supply | |
| Color | 30 mi | 60 mi | 30 mi | 60 mi | 30 mi | 60 mi | 30 mi | 60 mi | 30 mi | 60 mi |
| Blue | 5 | 16 | 3 | 20 | 2 | (4) | 1.7 | 0.8 | 2.8 | 1.3 |
| Red | 3 | 3 | 5 | 21 | (2) | (18) | 0.6 | 0.1 | 1.0 | 0.2 |
| . . . | . . . | . . . | . . . | . . . | . . . | . . . | . . . | . . . | . . . | . . . |
| Silver | 12 | 21 | 34 | 54 | (22) | (33) | 0.4 | 0.4 | 0.6 | 0.6 |
| Audio | 3 | 6 | 12 | 56 | (9) | (50) | 0.3 | 0.1 | 0.4 | 0.2 |
| Package | | | | | | | | | | |
| Sports | 2 | 5 | 3 | 3 | (1) | 2 | 0.7 | 1.7 | 1.1 | 2.8 |
| Package | | | | | | | | | | |
| . . . | . . . | . . . | . . . | . . . | . . . | . . . | . . . | . . . | . . . | . . . |

The last two columns represent indexed demand vs. supply. Entries greater than 1.0 suggest undersupply, whereas entries below 1.0 suggest oversupply. Thus, high-valued entries are indicative of vehicle-attributes that the dealer should increase in his inventory, and low-valued entries are indicative of those vehicle-attributes he should decrease.

For instance, suppose Table 11 reflects a particular model of vehicle, say the BMW 7-series and, in this case, at a specific local BMW dealership. Here, the indexed demand vs. supply indicator suggests that this dealer should be stocking up more on blue vehicles of this type (7-series), and add more cars with the sports package.

To produce the numbers in Table 11, the system may perform the following:
Demand: Count the total number of user certificates (special sales certificates) for BMW 7-series cars with each of the specific features or attributes over the past 4 weeks within N miles driving distance of this particular dealer's location.
Supply: For a snapshot of current inventory, count the number of BMW 7-series cars in the inventory within N miles of the past 4 weeks' Demand.
Demand−Supply: Subtract the supply column from the demand column.
Demand/Supply: Divide the demand by the supply. If supply=0, then set supply to 0.5 and perform calculation.
Indexed Demand/Supply: For all of this type of car (BMW 7-series), compute the average across entries in the table for Demand/Supply.

A “Days on Lot” metric can provide another indication. This can be indexed to averages for all vehicles in the region. Here, the average inventory days on lot is divided by the actual inventory days on lot for that particular set of vehicles. Computing in this way leads to entries with values higher than 1.0 suggesting an increase in inventory is warranted, and vice-versa for lower entries. This is shown in Table 12 below.

TABLE 12

| | Feature | | | | | | |
|---|---|---|---|---|---|---|---|
| | Indexed | | Avg Days | | Indexed Days | | |
| | Demand/Supply | | On Lot | | On Lot | | Re- |
| Color | 30 mi | 60 mi | 30 mi | 60 mi | 30 mi | 60 mi | stock? |
| Blue | 2.8 | 1.3 | 5 | 3 | 3.0 | 5.0 | 3.0 |
| Red | 1.0 | 0.2 | 12 | 18 | 1.3 | 0.8 | 0.8 |
| . . . | . . . | . . . | . . . | . . . | . . . | . . . | . . . |
| Silver | 0.6 | 0.6 | 20 | 28 | 0.8 | 0.5 | 0.6 |
| Entertain- | 0.4 | 0.2 | 35 | 29 | 0.4 | 0.5 | 0.4 |
| ment | | | | | | | |
| Package | | | | | | | |
| Sports | 1.1 | 2.8 | 8 | 8 | 1.9 | 1.9 | 1.9 |
| Package | | | | | | | |
| . . . | . . . | . . . | . . . | . . . | . . . | . . . | . . . |

The dealer can use this information to make decisions. Also, note that one embodiment would be to create a single restock metric to streamline the decision making process, as illustrated in Table 12 above. Here, the restock metric takes the average of the 30 miles+60 miles indexed demand/supply and indexed days on lot metrics. High values suggest that the dealer should restock vehicles with those attributes. Low values suggest that the dealer should reduce inventory for vehicles with this set of attributes.

Those skilled in the art will appreciate that additional and/or alternative parameters may be used. For example, the system may determine how many times visitors visiting a web site supported by the system viewed a certain trim-level vehicle configuration and determine, at the trim-level, the demand for the trim-level vehicle configuration and various attributes such as color. The system may also determine, at the trim-level, the supply for the trim-level vehicle configuration and various attributes, for instance, how many blue, red, . . . , silver cars are available within 20, 40, 60 miles of a dealer (inclusive of the dealer's own inventory). Based on a ratio of the determined demand over the determined supply, the system may make one or more recommendations to the dealer, for instance, “currently, blue cars are in demand, so you might want to increase your inventory on blue cars” or “reduce your inventory of cars with this option package.” Such dealer-specific recommendation(s) may be determined independent of a request from the dealer and stored in the dealer's vehicle data maintained by the system (e.g., vehicle data 225 of FIG. 2).

When requested, the system may retrieve recommendation(s) and relevant data from the dealer's vehicle data and display to the dealer, via a dealer portal, the demand relative to supply and corresponding recommendation(s). As an example, the system may display, via the dealer portal, pricing information of the particular dealer (e.g., via a histogram) relative to others in the same area (e.g., via a price curve) and/or relative to ranges of prices determined from others in the same area (e.g., via a price curve overlaid with price ranges). Additionally, the system may display, via the dealer portal, dealer-specific inventory supply and demand relative to other dealers supply and demand in the area (e.g., a geographic region defined by a radius of distance, traveling time, etc.).

Those skilled in the relevant art will appreciate that a data processing system can be used to implement embodiments disclosed herein. Such a data processing system may include one or more central processing units (CPU) or processors coupled to one or more user input/output (I/O) devices and memory devices. Examples of I/O devices may include, but are not limited to, keyboards, displays, monitors, touch screens, printers, electronic pointing devices such as mice, trackballs, styluses, touch pads, or the like. Examples of memory devices may include, but are not limited to, hard drives (HDs), magnetic disk drives, optical disk drives, magnetic cassettes, tape drives, flash memory cards, random access memories (RAMs), read-only memories (ROMs), smart cards, etc. The data processing system can be coupled to a display, an information device, and various peripheral devices, such as printers, plotters, speakers, etc. through I/O devices. The data processing system may also be coupled to external computers or other devices through a network interface, a wireless transceiver, or other means that is coupled to a network such as a local area network (LAN), wide area network (WAN), or the Internet.

Those skilled in the relevant art will appreciate that the invention can be implemented or practiced with other computer system configurations, including without limitation multi-processor systems, network devices, mini-computers, mainframe computers, data processors, and the like. The invention can be embodied in a special purpose computer or data processor that is specifically programmed, configured, or constructed to perform the functions described in detail herein. The invention can also be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer readable medium, hardware circuitry or the like, or any combination and that may be translatable by one or more server machines.

For example, ROM, RAM, and HD described above are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” or is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved by distributed or networked systems, components and circuits. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any, hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the accompanying appendices, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein and in the accompanying appendices, the meaning of “in” includes “in” and “on” unless the context clearly dictates otherwise. The scope of the present disclosure should be determined by the following claims and their legal equivalents.

What is claimed is:

1. A method, comprising:
a vehicle data system receiving vehicle sales data from one or more data sources communicatively connected to the vehicle data system, the vehicle data system having at least one processor, non-transitory computer memory, and stored instructions translatable by the at least one processor, the vehicle sales data including automotive transactions associated with a dealer in a geographic area, the dealer affiliated or registered with the vehicle data system;
the vehicle data system running analytics including analyzing the automotive transactions associated with the dealer in the geographic area relative to anonymized information on vehicle sales aggregated across multiple dealers in the geographic area;
the vehicle data system storing results from the analytics in a data store;
the vehicle data system receiving a request from a client device associated with the dealer to analyze dealer-specific vehicle sales in a particular time period;
the vehicle data system querying the data store with one or more parameters from the request, the one or more parameters including the particular time period;
the vehicle data system generating a custom user interface for the dealer based at least in part on the results from the analytics retrieved from the data store, the custom user interface including a visual representation of the dealer-specific vehicle sales and the anonymized information on the vehicle sales aggregated across the multiple dealers in the geographic area; and
the vehicle data system providing the custom user interface to the client device associated with the dealer.

2. The method according to claim 1, wherein the visual representation comprises a histogram representing the dealer-specific vehicle sales and a curve representing the anonymized information on the vehicle sales aggregated across the multiple dealers in the geographic area

3. The method according to claim 1, wherein the request is received via a web site, wherein the one or more parameters includes at least one filter selection by the dealer at the web site, and wherein generation of the custom user interface for the dealer comprises filtering the results from the analytics based on the at least one filter selection by the dealer.

4. The method according to claim 1, wherein the analytics further comprises:
determining a demand for vehicles with specific attributes and a supply of said vehicles with the specific attributes in the geographic area; and
making a recommendation for the dealer to optimize the dealer's inventory, wherein the recommendation is to increase or decrease a number of vehicles in the dealer's inventory having the specific attributes.

5. The method according to claim 4, wherein the recommendation is displayed on the client device via the custom user interface running on the client device.

6. The method according to claim 1, wherein the analytics further comprises:
determining if any of the automotive transactions associated with the dealer is to be excluded.

7. The method according to claim 1, wherein the analytics further comprises:
determining trim-level supplemental data associated with each vehicle in each automotive transaction of the automotive transactions associated with the dealer;
appending the trim-level supplemental data associated with the vehicle to a data structure;
determining what values in the data structure are missing or unreliable;
generating substitute values to replace missing or unreliable values in the data structure; and
storing the substitute values in the data structure such that the data structure has sufficient reference pricing data points for analyzing the automotive transactions associated with the dealer in the geographic area relative to the anonymized information on the vehicle sales aggregated across the multiple dealers in the geographic area.

8. A vehicle data system, comprising:
at least one processor;
non-transitory computer memory; and
stored instructions translatable by the at least one processor to perform:
receiving vehicle sales data from one or more data sources communicatively connected to the vehicle data system, the vehicle sales data including automotive transactions associated with a dealer in a geographic area, the dealer affiliated or registered with the vehicle data system;
running analytics including analyzing the automotive transactions associated with the dealer in the geographic area relative to anonymized information on vehicle sales aggregated across multiple dealers in the geographic area;
storing results from the analytics in a data store;
receiving a request from a client device associated with the dealer to analyze dealer-specific vehicle sales in a particular time period;
querying the data store with one or more parameters from the request, the one or more parameters including the particular time period;
generating a custom user interface for the dealer based at least in part on the results from the analytics retrieved from the data store, the custom user interface including a visual representation of the dealer-specific vehicle sales and the anonymized information on the vehicle sales aggregated across the multiple dealers in the geographic area; and
providing the custom user interface to the client device associated with the dealer.

9. The vehicle data system of claim 8, wherein the visual representation comprises a histogram representing the dealer-specific vehicle sales and a curve representing the anonymized information on the vehicle sales aggregated across the multiple dealers in the geographic area

10. The vehicle data system of claim 8, wherein the request is received via a web site, wherein the one or more parameters includes at least one filter selection by the dealer at the web site, and wherein generation of the custom user interface for the dealer comprises filtering the results from the analytics based on the at least one filter selection by the dealer.

11. The vehicle data system of claim 8, wherein the analytics further comprises:
determining a demand for vehicles with specific attributes and a supply of said vehicles with the specific attributes in the geographic area; and
making a recommendation for the dealer to optimize the dealer's inventory, wherein the recommendation is to increase or decrease a number of vehicles in the dealer's inventory having the specific attributes.

12. The vehicle data system of claim 11, wherein the recommendation is displayed on the client device via the custom user interface running on the client device.

13. The vehicle data system of claim 8, wherein the analytics further comprises:
determining if any of the automotive transactions associated with the dealer is to be excluded.

14. The vehicle data system of claim 8, wherein the analytics further comprises:
determining trim-level supplemental data associated with each vehicle in each automotive transaction of the automotive transactions associated with the dealer;
appending the trim-level supplemental data associated with the vehicle to a data structure;
determining what values in the data structure are missing or unreliable;
generating substitute values to replace missing or unreliable values in the data structure; and
storing the substitute values in the data structure such that the data structure has sufficient reference pricing data points for analyzing the automotive transactions associated with the dealer in the geographic area relative to the anonymized information on the vehicle sales aggregated across the multiple dealers in the geographic area.

15. A computer program product comprising at least one non-transitory computer readable medium storing instructions translatable by at least one processor of a vehicle data system to perform:
receiving vehicle sales data from one or more data sources communicatively connected to the vehicle data system, the vehicle sales data including automotive transactions associated with a dealer in a geographic area, the dealer affiliated or registered with the vehicle data system;
running analytics including analyzing the automotive transactions associated with the dealer in the geographic area relative to anonymized information on vehicle sales aggregated across multiple dealers in the geographic area;
storing results from the analytics in a data store;
receiving a request from a client device associated with the dealer to analyze dealer-specific vehicle sales in a particular time period;
querying the data store with one or more parameters from the request, the one or more parameters including the particular time period;
generating a custom user interface for the dealer based at least in part on the results from the analytics retrieved from the data store, the custom user interface including a visual representation of the dealer-specific vehicle sales and the anonymized information on the vehicle sales aggregated across the multiple dealers in the geographic area; and
providing the custom user interface to the client device associated with the dealer.

16. The computer program product of claim 15, wherein the visual representation comprises a histogram representing the dealer-specific vehicle sales and a curve representing the anonymized information on the vehicle sales aggregated across the multiple dealers in the geographic area

17. The computer program product of claim 15, wherein the request is received via a web site, wherein the one or more parameters includes at least one filter selection by the dealer at the web site, and wherein generation of the custom user interface for the dealer comprises filtering the results from the analytics based on the at least one filter selection by the dealer.

18. The computer program product of claim 15, wherein the analytics further comprises:
determining a demand for vehicles with specific attributes and a supply of said vehicles with the specific attributes in the geographic area; and
making a recommendation for the dealer to optimize the dealer's inventory, wherein the recommendation is to increase or decrease a number of vehicles in the dealer's inventory having the specific attributes, and wherein the recommendation is displayed on the client device via the custom user interface running on the client device.

19. The computer program product of claim 15, wherein the analytics further comprises:
determining if any of the automotive transactions associated with the dealer is to be excluded.

20. The computer program product of claim 15, wherein the analytics further comprises:
determining trim-level supplemental data associated with each vehicle in each automotive transaction of the automotive transactions associated with the dealer;
appending the trim-level supplemental data associated with the vehicle to a data structure;
determining what values in the data structure are missing or unreliable;
generating substitute values to replace missing or unreliable values in the data structure; and
storing the substitute values in the data structure such that the data structure has sufficient reference pricing data points for analyzing the automotive transactions associated with the dealer in the geographic area relative to the anonymized information on the vehicle sales aggregated across the multiple dealers in the geographic area.
